(19) United States
(12) Patent Application Publication
(10) Pub. No.: US 2026/0359569 A1
(43) Pub. Date: Nov. 12, 2026

(54) ARTIFICIAL INTELLIGENCE BASED STRATEGIC INNOVATION SYSTEM

(71) Applicant: Sluice AI, Inc., Austin, TX (US)

(72) Inventors: Rush BARTLETT, Austin, TX (US); Frank WANG, Zhubei City (TW)

(21) Appl. No.: 19/670,337

(22) Filed: May 7, 2026

Related U.S. Application Data
(60) Provisional application No. 63/801,722, filed on May 7, 2025.

(51) Int. Cl. G06F 40/284; G06F 3/0481; G06F 16/334; G06F 16/335

(52) U.S. Cl. CPC G06F 40/284; G06F 3/0481; G06F 16/334; G06F 16/335

(57) ABSTRACT

Certain embodiments provide a computer system that manages execution of autonomous workflow agents using a graph-based architecture with contextual dependency tracking and dynamic agent execution. Each agent node records metadata identifying specific upstream context segments used to generate outputs. A reverse dependency graph maps downstream nodes to such context segments. Upon detecting changes to upstream context, the system determines affected downstream nodes by evaluating whether modified portions correspond to recorded dependencies and whether such changes are materially relevant using embedding similarity and/or LLM analysis. Only downstream nodes determined to be materially impacted are selectively regenerated, thereby reducing computational overhead and improving efficiency of LLM usage.

### CROSS-REFERENCE TO RELATED APPLICATIONS

This application claims the benefit of U.S. Provisional Application Serial No. 63/801,722 (filed on May 7, 2025), the content of which is incorporated by reference herein in its entirety.

### BACKGROUND

The present disclosure relates to computer systems, and, more particularly, to an artificial intelligence (AI) based strategic innovation system.

Creating new products and services are challenging tasks that involve significant research, idea development, and testing. A variety of methodologies, such as Agile Development, Biodesign, Lean Startup, Design Thinking, the Theory of Inventive Problem Solving (TRIZ), and others, attempt to apply different innovation techniques in a standardized way so that any innovation team may be consistently successful. These innovation techniques may also use software tools, such as Excel, template-based applications, etc., to ensure that each step in the strategic innovation process has been completed before moving to the next step. Unfortunately, these innovation techniques contain flaws and pitfalls which often yield inconsistent results.

### BRIEF DESCRIPTION OF THE DRAWINGS

FIG. 1 depicts a block diagram of an example strategic innovation system, in accordance with embodiments of the present disclosure.

FIG. 2 depicts a block diagram of an example computer system, in accordance with embodiments of the present disclosure.

FIG. 3 depicts a software architecture block diagram for the strategic innovation system depicted in FIG. 1, in accordance with embodiments of the present disclosure.

FIG. 4A depicts example workflow modules, in accordance with embodiments of the present disclosure.

FIG. 4B depicts a data flow diagram for certain workflow submodules and tools, in accordance with embodiments of the present disclosure.

FIGS. 5–40 depict example graphical user interfaces (GUIs) associated with the strategic innovation system depicted in FIG. 1, in accordance with embodiment of the present disclosure.

### DETAILED DESCRIPTION

An “agentic” flow system is a framework in which autonomous “agents” dynamically interact, process information, and execute tasks in a coordinated, adaptive manner to achieve specific goals, while a non-agentic flow system operates based on predefined rules and requires human input for decision-making.

Current agentic flow systems follow a human-defined workflow through a series of discrete steps – often with multiple agents or “bots” that are working along a specific path or network as different tasks arrive to be performed. This human-defined flow may allow complex tasks to be broken down into discrete parts that are solved by specialized agents, such as a large language models (LLMs). An LLM may have a specific prompt that has access to tools, such as external functions or code generation capabilities to accomplish that task, throughout a network.

Review and verification agents may be used to refine outputs, check for errors, and check for sub-optimal outputs. However, current agentic flow systems may be limited because the agentic workflows are fixed, oftentimes following only one discrete sequence of agents to complete the task – even if the agentic flows offer multiple different agents. This produces a powerful but inflexible architecture when multiple users enter the system with a need or a product idea or other job to be done and follow a checklist of steps to arrive at their end goal.

Current human-defined workflows run within a single LLM. They are either trained or have a prompt that helps them break down the task, and then call different LLM bots as needed. This architecture prevents divergence from the workflow and limits creativity by not allowing users to explore ideas using agents that aren’t defined in that sequence of flow. This limitation may be frustrating to users and lead to less optimal interactions, which limits the value the users may gain from the system.

Conventional multi-agent orchestration systems additionally suffer from substantial computational inefficiencies arising from large-scale contextual dependency management across dynamically evolving execution graphs. In many implementations, downstream autonomous agents repeatedly reconstruct large contextual histories derived from upstream agent interactions in order to generate subsequent outputs. Because modern large language model (LLM) systems are inherently stateless inference systems, contextual reconstruction operations may require repeated transmission, serialization, and processing of large context windows across numerous downstream agents. As execution graphs grow in size and complexity, these repeated contextual reconstruction operations can cause excessive token utilization, increased inference latency, redundant model invocations, increased memory utilization, and substantial computational overhead across distributed execution environments.

Conventional workflow orchestration systems further suffer from contextual synchronization failures when upstream contextual information changes after downstream outputs have already been generated. In particular, conventional systems frequently lack mechanisms for determining which downstream outputs materially depend upon modified upstream contextual segments. As a result, conventional systems often trigger unnecessary full downstream recomputation operations or alternatively preserve stale downstream outputs generated using outdated contextual assumptions. These deficiencies may result in inconsistent execution states across distributed agent networks, propagation of stale contextual information, increased computational expense, and degradation in downstream output reliability.

Embodiments of the present disclosure advantageously provide a dynamic artificial intelligence (AI) based strategic innovation system that includes different unique agents or “bots” that do not have fixed connections. The sequences of bots are defined dynamically, as each bot contains a required input and an output or output goal that they are meant to perform. An over-arching application or a direction driving bot (or series of bots) may interpret user input and other outputs from other bots to decide which of any next series of bots may be employed. When the next bot or series of bots is determined, then the directional bot (or sub directional bot) may determine the input requirements for the bots that are identified, and then request the input requirements from either a human user and or other bots. The input requirements may be the output goals of other bots, and so on.

The strategic innovation system dynamically adjusts which bots are called based on how the input requirements are needed to satisfy the desired output goal or action to be taken in order to fulfill the request of the system by a user and or by another system or a bot. In this way, the workflow is not discretely defined or fixed, and new bots can be added at any time with new inputs and output goals associated with each of these new bots. After a new bot is added, the strategic innovation system may dynamically call on the new bots in order to accomplish the task at hand.

In current agentic flow systems, the workflow designer defines the workflow, in which the agents are arranged in a pre-defined workflow schema which restricts the ability of the agents to process data out of the sequence of the workflow. However, the goals of the strategic innovation system are constantly evolving, so the user may explore tangents after a particular task is completed. Additionally, the strategic innovation system has an open-ended goal – in other words, the strategic innovation system is not a task master that is seeking to accomplish a singular task at the end of a pre-defined sequence of tasks.

In an agentic flow system, the workflow designer specifies the goal and uses a prompt or a pre-trained LLM that breaks down the goal into smaller sub-tasks or a plan of action. Each task may be performed by the same agent with the same prompt, or another agent may be called. Each of the agents may have access to various tools, allowing the agent to access external resources.

In the strategic innovation system, an overarching LLM does not define a singular goal or generate a plan of action. Instead, each agent operates independently of the others, with each agent having its own immediate goals while being aware of the global goal. Upon accomplishing the agent’s immediate goal, the agent may determine which potential agents to call next to move closer to the global goal. Since there is no overarching LLM that monitors the progress, the strategic innovation system allows the user to interact with the agents at each step, which enables collaboration with the agents and allows for the agents to go off on tangents while maintaining focus on the global goal.

In some embodiments, the directional or routing functionality described herein may be implemented by one or more routing agents, routing modules, or routing tools that determine which downstream agents are instantiated based on the satisfaction of input dependencies, contextual relevance, or inferred alignment with the global goal. In some embodiments, input dependencies may be satisfied by retrieved contextual data from databases or external sources. Such routing functionality may be centralized, distributed, hierarchical, or optional. For example, the system may operate with zero routing agents, a single routing agent coordinating the overall workflow, or multiple routing agents operating in parallel or within different portions of the agent graph. In certain configurations, sub-routing agents may exist within particular workflow modules or subgraphs to locally coordinate downstream agent selection. These routing agents may evaluate available agents dynamically based on input availability, semantic similarity, contextual dependencies, or user preferences, and may autonomously activate one or more candidate agents concurrently. In this way, the system avoids reliance on a single centralized orchestrator and instead supports flexible routing across a dynamically evolving agent network.

In certain embodiments, the disclosed system includes (i) a dependency-based selective regeneration architecture and (ii) a dynamic activation-based agent execution architecture, which may be implemented independently or in combination.

In certain embodiments, the disclosed system includes a dependency-aware execution architecture configured to selectively activate downstream agents based on satisfaction of contextual dependency conditions associated with each agent node. Rather than requiring execution of predetermined sequential workflows, the system dynamically evaluates dependency metadata associated with available agents to determine whether sufficient contextual inputs exist for downstream execution. This architecture reduces unnecessary execution of irrelevant agents and improves computational efficiency in distributed execution environments containing large numbers of candidate autonomous agents.

In certain embodiments, the disclosed system further includes selective downstream regeneration mechanisms configured to reduce computational overhead associated with evolving contextual states. Upon detection of modification to contextual information associated with an upstream node, the system selectively determines which downstream nodes are materially impacted by the modified contextual segments using dependency metadata associated with downstream outputs. By limiting downstream regeneration operations to affected dependency branches rather than triggering full downstream recomputation, the system reduces unnecessary LLM invocations, reduces token consumption, improves execution latency, and improves scalability across dynamically evolving multi-agent execution graphs.

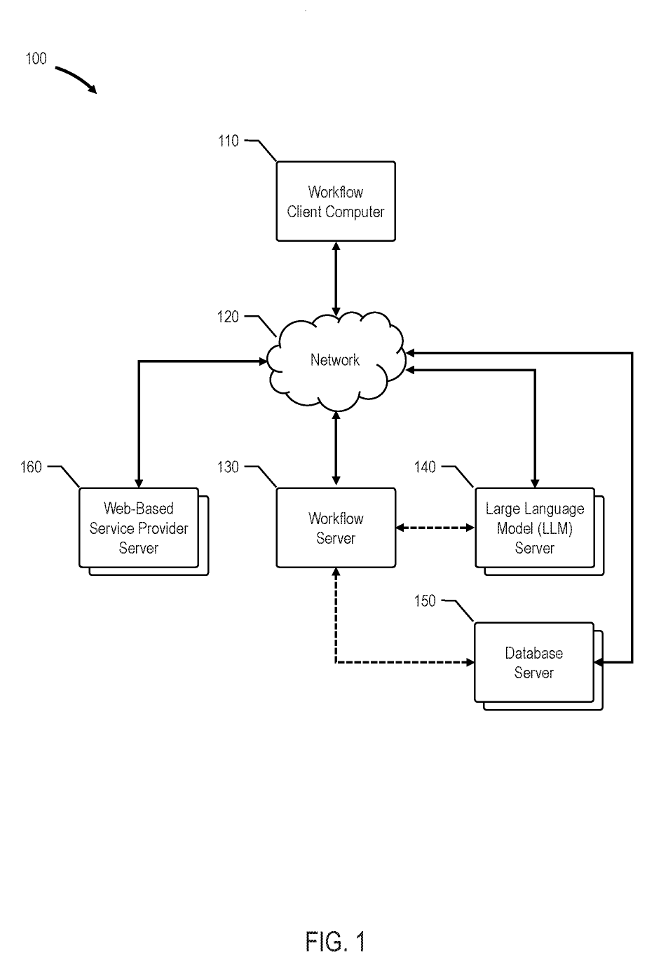

The strategic innovation system will now be described with respect to FIGS. 1–4B.

FIG. 1 depicts a block diagram of a strategic innovation system 100, in accordance with embodiments of the present disclosure.

In certain embodiments, the strategic innovation system 100 includes a workflow client computer 110 coupled to a network 120, a workflow server 130 coupled to the network 120, one or more LLM servers 140 coupled to the network 120, one or more database servers 150 coupled to the network 120, and one or more web-based service provider servers 160 coupled to the network 120.

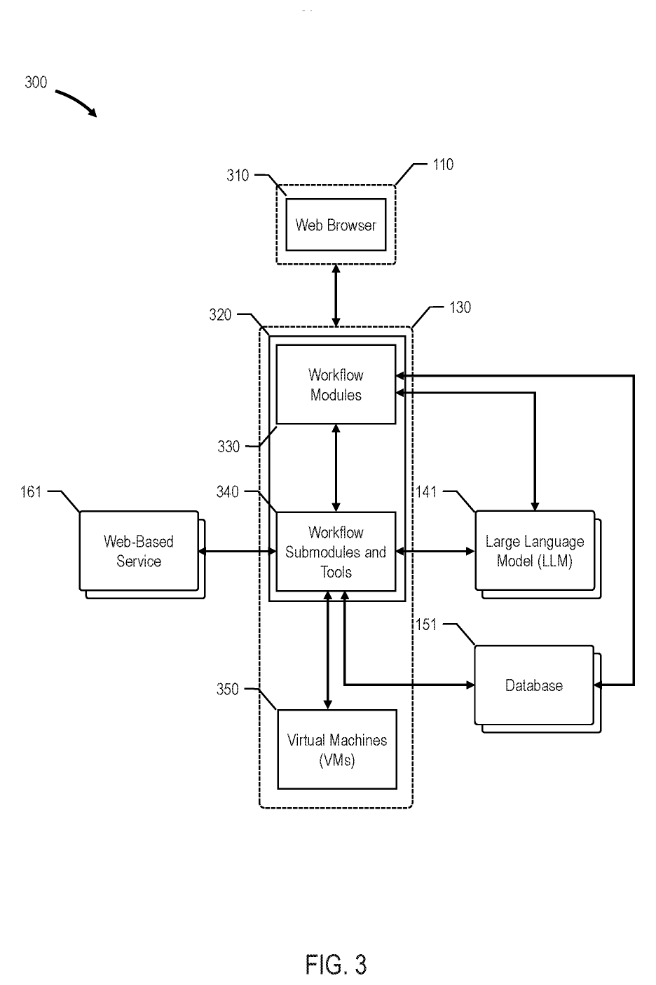

The workflow client computer 110 may be a desktop computer, a laptop computer, a tablet computer, a smartphone, etc. The workflow client computer 110 may request relevant services from and access relevant applications executed by the workflow server 130, such as an AI-assisted strategic innovation application 320 (depicted in FIG. 3), etc., using a client-server architecture. More particularly, the workflow client computer 110 may present one or more graphical user interfaces (GUIs) received from the workflow server 130 to the user (e.g., using a web browser, mobile application, desktop application, etc.). Generally, the GUIs prompt the user to provide input data for the workflow server 130, and display workflow output data and results from the workflow server 130.

The network 120 may include one or more local area networks (LANs), wide area networks (WANs), the Internet, etc., which may execute various network protocols, such as Ethernet, Synchronous Optical Networking (SONET), HyperText Transfer Protocol (HTTP), etc. The network 120 may include different types of physical connections, such as shielded or unshielded twisted pair copper wires, coaxial cables, fiber optic cables, wireless connections (e.g., WiFi), cellular connections (e.g., Global System for Mobile Communication (GSM), Code-Division Multiple Access (CDMA), Long-Term Evolution (LTE)), etc. The network 120 also includes a number of layers above the physical layer. For example, the Open Systems Interconnection (OSI) model includes physical, data link, network, transport, session, presentation, and application layers. In another example, the Transmission Control Protocol/Internet Protocol (TCP/IP) model includes application, transport, Internet, and network access layers.

The workflow server 130, the LLM server 140, the database server 150, and the web-based service provider server 160 may be network servers, virtual private servers such as cloud servers, etc.

The workflow server 130 may execute one or more server applications, such as an application server, a web server, an HTTP server, etc., to which the workflow client computer 110 may connect through network 120. More particularly, the workflow server 130 may be configured to execute an AI-assisted strategic innovation application 320 that interacts with the workflow client computer 110, the LLM servers 140, the database servers 150, and the web-based service provider servers 160. The AI-assisted strategic innovation application may include, inter alia, workflow modules 330, workflow submodules and workflow tools (i.e., the workflow submodules and tools 340), virtual machines (VMs) 350, etc. (depicted in FIG. 3), and may generate one or more GUIs for transmission to the workflow client computer 110, as described in more detail below. The workflow server 130 includes a memory (e.g., memory 250) that is configured to store the AI-assisted strategic innovation application 320 including the workflow modules 330 and the workflow submodules and tools 340.

In some embodiments, the AI-assisted strategic innovation application may be hosted by the workflow client computer 110, and the strategic innovation system 100 would not include the workflow server 130.

The LLM server 140 may execute one or more server applications, such as an application server, a web server, an HTTP server, etc., to which the workflow server 130 may connect through networks 120. More particularly, an LLM server 140 may be configured to execute an LLM, such as a Generative Pre-trained Transformer (GPT), etc., and service requests (such as prompts) from the workflow server 130 using a client-server architecture. The LLM server 140 generates a completion response for each prompt, and sends the completion responses to the workflow server 130.

In some embodiments, the LLM may be hosted by the workflow server 130 (or the workflow client computer 110), and the strategic innovation system 100 would not include the LLM server 140.

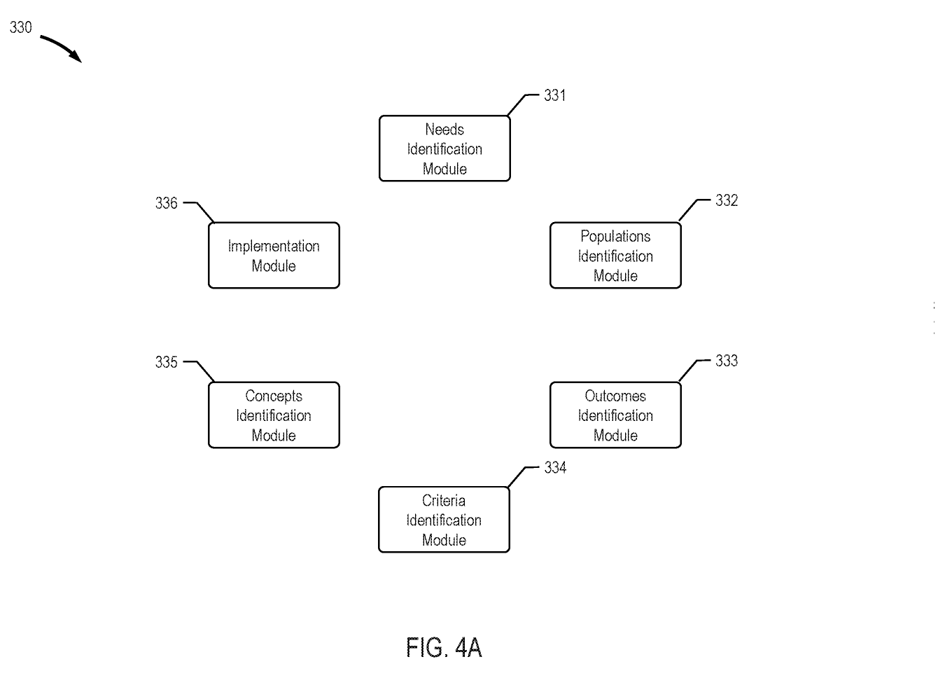

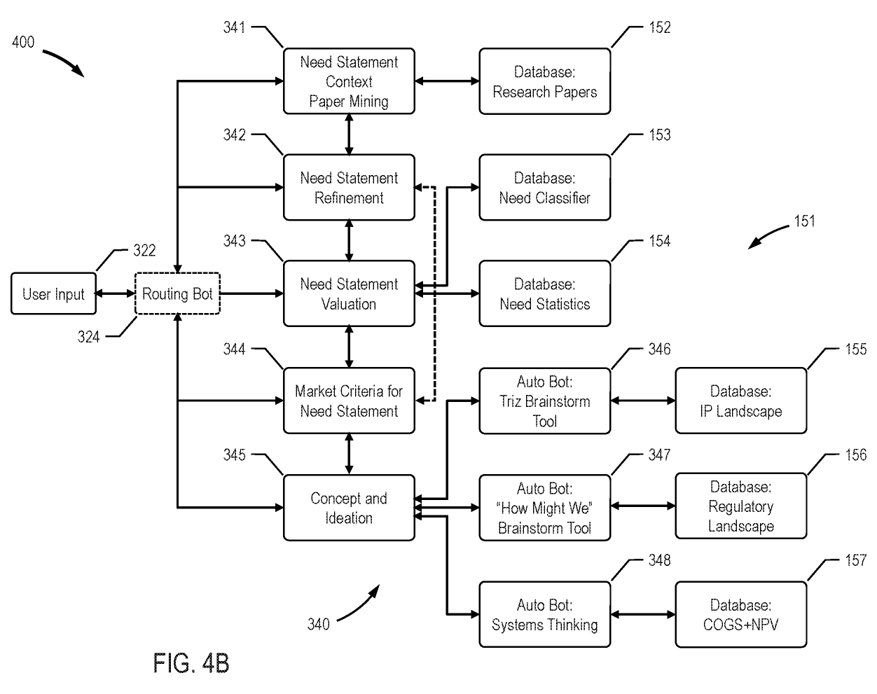

The database servers 150 may execute one or more server applications, such as an application server, a web server, an HTTP server, etc., to which the workflow server 130 may connect through the network 120. More particularly, a database server 150 may be configured to execute a database application to provide access to one or more databases, such as a research papers database 152, a need classifier database 153, a need statistics database 154, an intellectual property (IP) landscape database 155, a regulatory landscape database 156, a cost of goods sold (COGS) + net present value (NPV) database 157, etc. (see FIG. 4B).

In some embodiments, one or more of the databases may be hosted by the workflow server 130 (or the workflow client computer 110), and the strategic innovation system 100 may not include all of the database servers 150.

The web-based service provider servers 160 may execute one or more server applications, such as an application server, a web server, an HTTP server, etc., to which the workflow server 130 may connect through the network 120. More particularly, a web-based service provider server 160 may be configured to host one or more web-based services that are accessed using an application programming interfaces (API), such as Google Search, Pubmed, etc.

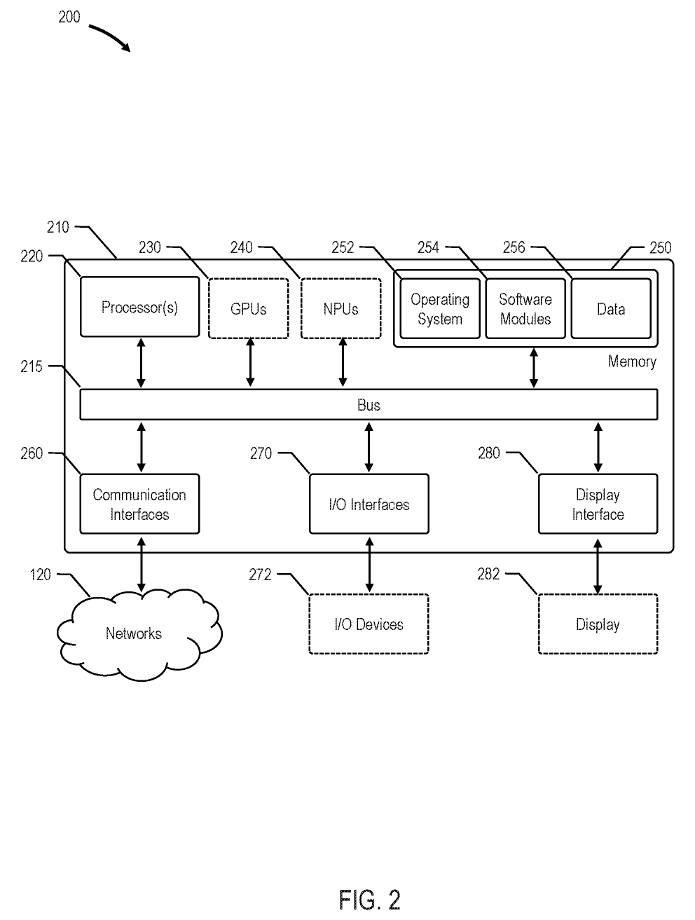

FIG. 2 depicts a block diagram of an example computer system 200, in accordance with embodiments of the present disclosure.

In certain embodiments, the computer system 200 may include, inter alia, a computer 210 coupled to the network 120, one or more input/output (I/O) devices 272, and a display 282. The workflow client computer 110, the workflow server 130, the LLM servers 140, the database servers 150, and the web-based service provider servers 160 may include the same components, a subset of the components, or a superset of the components of the computer system 200. For example, the workflow server 130, the LLM servers 140, the database servers 150, and the web-based service provider servers 160 may include the computer 210 but not the I/O devices 272 or the display 282.

The computer 210 may include, inter alia, a bus 215, one or more processors 220, a storage element or memory 250, one or more communication interfaces 260, one or more I/O interfaces 270, and a display interface 280. In some embodiments, the computer 210 may also include one or more specialized processors, such as one or more graphics processing units (GPUs) 230, one or more neural processing units (NPUs) 240, etc. The specialized processors may be particularly useful for executing ML and other applications, such as artificial neural networks (ANNs), the AI-assisted strategic innovation application executed by the workflow server 130, the LLMs executed by the LLM servers 140, the services hosted by the web-based service provider servers 160, etc.

The bus 215 is a communication system that transfers data between the processor 220, the memory 250, the communication interfaces 260, the I/O interfaces 270, and the display interface 280. In some embodiments, the bus 215 also transfers data between these components and the GPUs 230 and the NPUs 240.

The processor 220 may include one or more general-purpose or application-specific single-core or multi-core microprocessors that execute instructions to perform control, computation, and input/output functions for the computer 210. The processor 220 may include a single integrated circuit, such as a microprocessing device, or multiple integrated circuit devices or circuit boards working in cooperation to accomplish the appropriate functionality. In addition, the processor 220 may execute computer programs and modules, such as an operating system 252, software modules 254, etc., stored within the memory 250.

Generally, the memory 250 stores processor instructions for managing, retrieving, processing, presenting, and storing data. The memory 250 may include a variety of transitory and non-transitory computer-readable medium that may be accessed by the processor 220 as well as other components coupled to the bus 215. For example, the memory 250 may include any combination of random access memory (RAM), dynamic RAM (DRAM), static RAM (SRAM), read only memory (ROM), cache memory, flash memory, solid state drives (SSDs), hard disk drives (HDDs), etc.

The processor instructions may be organized as an operating system 252 and a number of software modules 254. The operating system 252 manages hardware resources, provides a platform on which applications are executed, and facilitates communication between the processor 220, memory 250, the I/O devices 272, and the display 282. The software modules 254 provide organized, reusable units of code that perform specific functions within the computer system 200, such as applications, libraries, etc. For example, one or more software modules 254 stored in the memory 250 of the workflow server 130 may include the AI-assisted strategic innovation application. Additionally, the operating system 252 and the software modules 254 may cooperate with the communication interfaces 260 to transmit and receive data over the network 120. The data 256 may include data associated with the operating system 252, the software modules 254, etc.

The communication interfaces 260 are configured to transmit and receive data over the network 120 using different types of physical connections, such as shielded or unshielded twisted pair copper wires, coaxial cables, fiber optic cables, WiFi connections, GSM, CDMA or LTE cellular connections, etc. As discussed above, the network 120 may include one or more LANs, WANs, the Internet, etc., which may execute various network protocols, such as Ethernet, SONET, HTTP, etc.

The I/O interfaces 270 are configured to transmit and receive data from I/O devices 272. The I/O interfaces 270 enable connectivity between the processor 220, the memory 250, and the I/O devices 272 by encoding data to be sent from the processor 220 or the memory 250 to the I/O devices 272, and decoding data received from the I/O devices 272 for the processor 220 or the memory 250. Generally, data may be sent over wired and/or wireless connections. For example, the I/O interfaces 270 may include one or more wired communications interfaces, such as universal serial bus (USB), etc., and one or more wireless communications interfaces, such as Bluetooth, WiFi, etc.

The I/O devices 272 provide input to the computer 210 and output from the computer 210. As discussed above, the I/O devices 272 are operably connected to the computer 210 using wired and/or wireless connections. The I/O devices 272 may include a local processor coupled to a communication interface that is configured to communicate with the computer 210 using the wired and/or wireless connection. For example, the I/O devices 272 may include a keyboard, mouse, touch pad, joystick, etc.

The display interface 280 is configured to transmit image data from computer 210 to the display 282.

FIG. 3 depicts a software architecture block diagram 300 for the strategic innovation system 100, in accordance with embodiments of the present disclosure.

The workflow client computer 110 executes a client-side application, such as a web browser 310, a mobile application, a desktop application, etc., that presents one or more GUIs that prompt the user to provide input data for the workflow server 130, and display workflow output data and results from the workflow server 130.

The workflow server 130 executes the AI-assisted strategic innovation application 320 which includes, inter alia, process management software, workflow modules 330, workflow submodules and tools 340, etc.

The workflow modules 330 implement functionality that performs various task associated with open-ended high level goals such as identifying needs, help user generate concepts, etc. The workflow modules 330 may include, inter alia, prompts and a list of tools one or more LLMs may choose to call to accomplish the task set by the prompt.

The workflow submodules and tools 340 include a number of workflow submodules and a number of workflow tools which may also be known as agents, as described above. A workflow submodule may include specific prompts to achieve a specific goal such as evaluate a need statement, or calculate the economic value of a certain idea. A workflow tool may be computer code that performs a certain task, such as opening a browser to go to Google.com, converting an image into text, etc. A workflow tool may leverage an LLM, such as converting a Portable Document Format (PDF) file to text. For example, a workflow tool may execute (interpret) Python code to convert the PDF to an image, then request an LLM to convert the image to text. A workflow tool may also leverage one or more web-based services 161, such as Google Search, Pubmed, etc., provided by web-based service provider servers 160.

The workflow submodules and tools 340 may also be known as agents within the strategic innovation system 100, as described above with respect to an agentic flow system.

The workflow server 130 may also provide one or more VMs 350 for use by the workflow tools. A workflow tool may leverage a VM 350 to run applications in a protected or sandboxed environment to prevent data leaking between users of the strategic innovation system 100. For example, a VM 350 may execute a browser to browse a website which is easily read by an LLM as an image instead of raw HyperText Markup Language (HTML) code. The same is true for tables, figures, graphs, PDF. A VM 350 may also execute (interpret) Python code to calculate numbers, process data, etc.

In certain embodiments, execution of autonomous agents may occur asynchronously across distributed compute resources including distributed virtual machines, containerized execution environments, remote inference servers, or heterogeneous compute nodes. The system may dynamically schedule execution of autonomous agents based on dependency satisfaction conditions, execution priority metrics, contextual relevance scores, available computational resources, or predicted execution costs associated with downstream inference operations.

In certain embodiments, the system further maintains execution-state metadata associated with autonomous agent nodes in order to coordinate synchronization across concurrently executing branches of the execution graph. Such execution-state metadata may identify dependency resolution status, contextual validity states, regeneration requirements, execution timestamps, contextual version identifiers, or downstream invalidation indicators associated with one or more autonomous agents.

The LLMs 141 process, understand, and generate human-like text by leveraging vast datasets and complex neural networks, and is typically based on transformer architectures. The LLMs 141 function by predicting the next word or sequence in a given context, in order to perform tasks such as answering questions, summarizing text, translating languages, generating creative content, and even engaging in conversational dialogue. The LLMs 141 are trained on diverse text sources to capture patterns in grammar, semantics, and world knowledge, in order to produce coherent and contextually relevant responses.

The databases 151 are structured systems for storing, managing, and retrieving data efficiently. Generally, the databases 151 may organize information into tables, where each table contains rows and columns, allowing for easy querying and manipulation using languages like the Structured Query Language (SQL). The databases 151 provide various functions, such as data insertion, updating, deletion, and searching, while ensuring data integrity through constraints and relationships. The databases 151 process large volumes of data, provide concurrent access for multiple users, and maintain security through user authentication and access controls. More particularly, the databases 151 not only store data needed to support the AI-assisted strategic innovation application 320, such as chat logs, prompts, etc., but also store text embeddings, generated knowledge graph, raw text of various data sources, such as entire patent database text. For example, one or more databases 151 may be used to find the appropriate context, which is then passed to the LLM 141 as a source of truth.

As used herein, the term “database” is intended to be broadly interpreted and may include, without limitation, a variety of structured and unstructured data storage systems. These may comprise relational databases (e.g., SQL-based systems), non-relational (NoSQL) databases (e.g., document stores, key-value stores, wide-column stores), graph databases (e.g., those optimized for storing and querying relationships between entities), vector databases (e.g., for storing and retrieving high-dimensional embeddings used in machine learning and semantic search), time-series databases (e.g., for storing data indexed by time), object-oriented databases, multimodal databases (capable of storing and querying across multiple data formats such as text, images, and audio), in-memory databases, distributed databases, and cloud-native data warehouses. These databases (and/or the system itself) may be implemented using a variety of technologies and architectures, and may reside locally, on edge devices, or in cloud-based infrastructure or in any combination thereof in whole or in part. They may support real-time or batch data processing, and be optimized for different performance trade-offs depending on the nature of the data and queries involved.

Advantageously, the AI-assisted strategic innovation application 320 manages the execution of the workflow modules 330 and the workflow submodules and tools 340 based on the user input data received from the workflow client computer 110 and the workflow output data generated by the workflow modules 330 and the workflow submodules and tools 340. In other words, the order of execution of the workflow modules 330 and the workflow submodules and tools 340 is not based on a predetermined sequence.

Advantageously, the disclosed architecture improves operation of distributed autonomous execution systems by reducing unnecessary downstream recomputation operations associated with evolving contextual dependencies. In particular, the system selectively propagates contextual modifications across dependency-linked execution nodes while preserving unaffected downstream outputs. This selective propagation architecture reduces redundant contextual reconstruction operations, reduces large language model invocation frequency, reduces token utilization associated with repeated contextual transmission, and improves execution scalability for large autonomous execution graphs.

Advantageously, the disclosed architecture further improves contextual synchronization integrity across distributed autonomous agent environments by maintaining explicit dependency mappings between downstream outputs and upstream contextual segments used during generation of those outputs. This enables the system to selectively invalidate or regenerate only materially impacted downstream outputs in response to upstream contextual modifications, thereby reducing propagation of stale contextual assumptions across distributed execution branches.

In certain embodiments, the disclosed architecture additionally improves execution parallelization efficiency by dynamically enabling concurrent execution of multiple candidate downstream agents whose dependency conditions are satisfied. By supporting selective concurrent activation of dependency-satisfied agent branches, the system reduces serialized execution bottlenecks commonly associated with conventional fixed-sequence orchestration systems.

### Example Workflow

In one example workflow, a biodesign workflow may be defined as including several high-level steps, including a stakeholder alignment and filter and rank criteria definition stage, an identify needs step, an identify populations step, an identify outcomes step, an identify criteria step, and identify concepts step, and an implementation step. The biodesign workflow may include a number of workflow modules, workflow submodules, and workflow tools to accomplish the goals of the high-level steps.

In the stakeholder alignment stage (and or wherever the system or user chooses to apply), the system may enable filtering and ranking of needs, stakeholder market selection criteria must or nice to haves, product requirements, concepts, or solution types across a wide range of metrics, each of which may be considered independently or in combination. These metrics may include, but are not limited to, technical feasibility, market potential, regulatory risk, speed to market, innovation novelty, resource requirements, and alignment with corporate or individual strategy. Crucially, the relative importance (weighting) and prioritization of these metrics may be determined by one or many user-defined or system-generated personas, which represent different stakeholder perspectives. Personas may be based on explicit input, such as direct responses to structured interviews or questionnaires, or implicit behavioral analysis, such as historical user interactions, prior selections, or pattern recognition across sessions or ongoing use of the system by the user or multiple users at the same organization which may be sub-segmented by user profile type and or kept unified if desired. Personas may be configured to reflect internal roles (e.g., engineering, marketing, finance), external stakeholder interests (e.g., acquirers, regulators, investors), or hypothetical profiles (e.g., “early adopter customer,” “cost-conscious buyer,” “risk-averse decision maker”). Each persona may define a custom ranking rubric and filtering strategy, thereby influencing the prioritization of needs and concepts throughout the innovation process. These personas may be used individually or in groups to simulate multi-stakeholder consensus or divergent priorities across departments or strategic objectives. Furthermore, the system may dynamically adjust or generate new persona models via conversational or AI-assisted interviews, allowing for evolving input without requiring exhaustive manual configuration. This multi-persona framework enables comparative analysis of strategic innovation pathways—e.g., how the same set of ideas would be evaluated under different business models, acquisition strategies, or technical competencies—and supports iterative experimentation with alternative filters, ranking schemes, and success criteria.

FIG. 4A depicts example workflow modules 330, in accordance with embodiments of the present disclosure.

In certain embodiments, the workflow modules 330 may include, inter alia, a needs identification module 331, a populations identification module 332, a outcomes identification module 333, a criteria identification module 334, a concepts identification module 335, and an implementation module 336.

The needs identification module 331 may identify unmet needs to be solved by innovations. An unmet need may be a gap or problem in the market, society, or technology that lacks an effective solution. The unmet need represents an opportunity for new products, services, or processes to address challenges that existing offerings fail to solve adequately, often due to limitations in functionality, accessibility, affordability, or awareness. Identifying unmet needs drives innovation by focusing efforts on creating value where demand exists but is underserved.

Because unmet needs may not be constrained to a single need, the needs identification module 331 may constantly update the unmet needs by adding and refining the needs recommendations. The needs identification module 331 may call one or more workflow submodules to assist in the identification of unmet needs, such as a need statement context workflow submodule 341, a need statement refinement workflow submodule 342, a need statement valuation workflow submodule 343, etc. (depicted in FIG. 4B).

The populations identification module 332 may identify, inter alia, one or more populations of stakeholders that express the unmet needs.

The outcomes identification module 333 may identify, inter alia, outcomes that define one or more objectives of the identified population of stakeholders.

The criteria identification module 334 may identify, inter alia, various criteria for the strategic innovation process, such as market criteria for a need statement, performance criteria, stakeholder criteria, etc. The criteria identification module 334 may call one or more workflow submodules to assist in the identification of criteria, such as a market criteria workflow submodule 344 (depicted in FIG. 4B).

In certain embodiments, the strategic innovation system may perform simultaneous exploration of both problem definitions and potential solutions rather than requiring that need statements be finalized prior to ideation. For example, the system may generate multiple candidate need statements while simultaneously generating potential solution concepts for each candidate need. Feedback generated during the solution exploration phase may then inform refinement of the original need statements. This bidirectional exploration allows the system to iteratively converge toward problem definitions and solutions that mutually reinforce one another.

The concepts identification module 335 may identify, inter alia, concepts and ideas that satisfy the identified criteria. The concepts identification module 335 may call one or more workflow submodules to assist in the identification of criteria, such as a concept/ideation workflow submodule 345 to assist in the identification of the concepts and ideas for the solution. In certain embodiments, the system may operate as a dynamic feedback loop during the ideation and need-identification processes, enabling continuous and iterative refinement with one or more steps of negative feedback and refinement of that feedback to evolve need statements and or solution ideas and or the criteria of the market stakeholders or other aspects of this or other system use case examples. Rather than following a strictly sequential pipeline, the system may perform simultaneous or interleaved evolution of both need statements and potential solution concepts. As part of this, the system may identify logical flaws, conflicting assumptions, or underdeveloped elements within a proposed concept and trigger updates to either the idea, the originating need statement, or the criteria applied. For example, changes to a need statement—such as increased technical specificity or reframing of the user pain point—may result in the system autonomously selecting or recommending a different brainstorming method better suited to that revised need (e.g., TRIZ vs. systems thinking vs. design thinking vs. biomimicry vs. counterfactual ideation, etc.). Additionally, the system may fragment a need or problem statement into subcomponents and apply multiple brainstorming approaches in parallel, in the background, generating diverse solution sets. These may then be filtered and ranked not only according to predefined criteria but also in relation to how well they respond to the evolved need context. In some cases, both the updated need and the resulting solutions may be scored and clustered dynamically, allowing tangential or non-obvious ideas to emerge that better solve the problem than initially expected. The system may further generate candidate solution ideas and subject them to critical evaluation using stakeholder-defined criteria, market conditions, and other structured or inferred data captured throughout the workflow—enabling iterative refinement and prioritization of ideas toward those most likely to achieve real-world viability and market acceptance for the given need statement area through one or more iterative evolutionary refinement loops. This continuous, reflexive interaction between needs, concepts, and criteria enhances the discovery of high-quality, innovative, and context-sensitive solutions beyond what is possible through linear, rule-based workflows alone.

The implementation module 336 may, inter alia, identify and evaluate the concepts and ideas in the context of the unmet needs. The evaluation facilitates the refinement of the solution and commercialization of the solution to solve the unmet need.

FIG. 4B depicts a data flow diagram 400 for certain workflow submodules and tools 340, in accordance with embodiments of the present disclosure.

Generally, the data flow diagram 400 depicts an example of the autonomous processing flow of the AI-assisted strategic innovation application 320, which is based on input data received from the workflow client computer 110 and the workflow output data generated by the workflow submodules. The workflow tools may be called by the workflow submodules by sending requests to the workflow tools. As described above, the workflow submodules and tools 340 may also be known as agents.

The need statement context workflow submodule 341 may be coupled to a research papers database 152 in order to “mine” research papers to generate a need statement context. The input to the need statement context workflow submodule 341 may include the context for need statement observation. The need statement context workflow submodule 341 may be called by the needs identification module 331, the AI-assisted strategic innovation application 320 in response to receiving user input data 322, an optional routing bot 324, or another workflow module 330.

While the research papers database 152 may contain academic publications and scientific articles, it should be understood that the system is not limited to this data type. The database 152, or any similar data source coupled to the need statement context workflow submodule 341 or any other workflow module, may also include or access a wide variety of content such as patent documents, technical manuals, internal reports, product reviews, regulatory filings, white papers, user or other stakeholder focused videos or audio, market research studies, competitive intelligence briefs, artificially generated simulation data, clinical trial data, user forums, standards documentation, and any other multimodal, textual or structured data relevant to innovation analysis. Furthermore, these data sources may be local, cloud-based, or externally hosted, and may be accessed through traditional database queries, retrieval-augmented generation (RAG) pipelines, or by making real-time API calls to third-party services (e.g., academic indexing platforms, patent databases, enterprise knowledge graphs, or proprietary vendor datasets). The system may incorporate capabilities for semantic search, vector-based similarity matching, metadata filtering, or hybrid approaches, thereby enabling intelligent retrieval of relevant contextual information across heterogeneous data ecosystems to support dynamic and informed generation of need statements or other innovation-related outputs.

The need statement refinement workflow submodule 342 may generate a need statement based on the context for need statement observation. The need statement refinement workflow submodule 342 may be called by the needs identification module 331, the AI-assisted strategic innovation application 320 in response to receiving user input data 322, an optional routing bot 324, or another workflow module 330 such as the need statement context workflow submodule 341.

The need statement valuation workflow submodule 343 may be coupled to a need classifier database 153 and a need statistics database 154 in order to generate economic value numbers. The input to the need statement valuation workflow submodule 343 may include the need statement, costs, and incidence numbers. The need statement valuation workflow submodule 343 may be called by the needs identification module 331, the AI-assisted strategic innovation application 320 in response to receiving user input data 322, an optional routing bot 324, or another workflow module 330 such as the need statement refinement workflow submodule 342.

The market criteria workflow submodule 344 may generate a need statement based on the context for need statement observation. The market criteria workflow submodule 344 may be called by the criteria identification module 334, the AI-assisted strategic innovation application 320 in response to receiving user input data 322, an optional routing bot 324, or another workflow module 330 such as the need statement valuation workflow submodule 343 or the need statement refinement workflow submodule 342.

The concept/ideation workflow submodule 345 may generate possible concepts based on the need statement and the stakeholder criteria. The concept/ideation workflow submodule 345 may be called by the concepts identification module 335, the AI-assisted strategic innovation application 320 in response to receiving user input data 322, an optional routing bot 324, or another workflow module 330 such as the market criteria workflow submodule 344.

In certain embodiments, multiple innovation methodologies may be executed in parallel or semi-parallel by the strategic innovation system in order to generate diverse perspectives on a need statement, problem definition, or solution concept. For example, different agents may apply different innovation frameworks such as design thinking, TRIZ, biomimicry, Lean methodology, systems thinking, ethnographic research techniques, stakeholder inquiry methods, customer discovery frameworks, or biodesign needs-finding methodologies. Each methodology-specific agent may analyze the same input need statement or problem definition using the reasoning patterns associated with that methodology. The outputs generated by these agents may then be compared, clustered, filtered, or ranked to identify convergent insights or novel solution opportunities. By allowing multiple methodological perspectives to operate concurrently, the system increases the likelihood of discovering innovative solutions that might not emerge from a single innovation framework alone.

The key is that at each different part of the system, such as needs finding, concept generation, business model creation, and/or validation of any of these, there are different process techniques and ways in which you may want to do all of these things. For example, you could instruct the system to run each different process at the same time to create a diversity of needs, ideas, validation data / invalidation data, assumptions, insights, business models, competitive landscape mapping, etc. all from different perspectives. This process is not just limited to the solution generation side but to any of the steps and layers within the system. The overarching theme is that more ideas lead to better ideas, more needs leads to better needs, more insights leads to better insights, and so on. The filtering and evaluation steps throughout drive down selections. In other words, this multi-threading approach dynamically changes the architecture which improves the overall result.

In some embodiments, ideation agents may simulate the reasoning patterns associated with particular personas, historical figures, professional archetypes, or fictional characters in order to generate diverse solution concepts. For example, a persona-based agent may attempt to solve a problem using reasoning patterns inspired by prominent scientists, engineers, entrepreneurs, policy makers, or other representative viewpoints. Similarly, fictional or speculative personas derived from science fiction narratives or imaginative scenarios may be used to generate unconventional solution concepts. These persona-based ideation agents may produce candidate concepts that reflect the decision-making styles, problem-solving heuristics, or mental models associated with those personas.

In certain embodiments, speculative or imaginative solution concepts generated by persona-based or creative ideation agents may be evaluated and translated into practical implementations by additional agents. For example, an imaginative concept generated by a speculative ideation agent − such as a concept inspired by science fiction or hypothetical technologies − may be analyzed by engineering translation agents that attempt to map the speculative concept into feasible technological mechanisms using currently known scientific principles. These translation agents may propose candidate physical mechanisms, engineering approximations, or alternative technological pathways capable of approximating the originally proposed speculative functionality.

The concept/ideation workflow submodule 345 may request that the TRIZ brainstorm workflow tool 346 generate TRIZ based solutions, request that the how-might-we brainstorm workflow tool 347 generate how-might-we based solutions, and request that the systems thinking workflow tool 348 generate systems thinking based solutions. Additionally, in parallel or sequentially other ideation tools may be called to generate other concepts or embodiments of solutions using other methodologies like SCAMPER, Lean Methodology, Jobs to be Done, etc. For example, the SCAMPER method is a structured tool that emphasizes altering familiar concepts or materials to create something new and encourages people to take an old idea and substitute (S), combine (C), adapt (A), modify (M), put to another use (P), eliminate (E), and reverse (R). In the case of parallel or alternative scoping of which concept/ideation workflow submodules could be called alone or in combination, the system may also modify or scope one or more-word elements of the input need statement and/or criteria such that the framing of the need statement to be solved and or it’s associated stakeholder criteria would be more relevant to one or more methodologies. Further, the TRIZ brainstorm workflow tool 346 may query the IP landscape database 155 to generate IP evaluation and citations, the how-might-we brainstorm workflow tool 347 may query the regulatory landscape database 156 to generate regulatory evaluation and citations, and the systems thinking workflow tool 348 may query the COGS+NPV database 157 to generate COGS and plan NPV and citations.

Advantageously, in the strategic innovation system 100, the starting agent is one that does not require any inputs. In each of the high-level steps, the starting agent allows the user to interact with the agent LLM to achieve that particular agent’s local goal. In the starting agent, the LLM asks the user, what topic are you interested in with the goal being identifying a topic of interest. Once the goal is reached, the AI-assisted strategic innovation application 320 identifies which agents have their input dependencies satisfied and for those agents, creates new instances of them as child to the starting agent. In other words, each one of the workflow submodules is configured to dynamically determine whether input dependencies are satisfied prior to execution.

In one example, the user may initially enter the text “I am interested in doing heart failure research” at a starting agent. In response, the agent identifies “heart failure” as satisfying its local goal, and the AI-assisted strategic innovation application 320 determines that a “Literature Research” agent and a “Where to Observe” agent now have their dependency satisfied, and creates a new instance of each agent as a child of the starting agent. The AI-assisted strategic innovation application 320 has access to the graph of all agents and their context to determine which agent to enable at each node. The AI-assisted strategic innovation application 320 may precompute the input and output dependencies of each agent once with or without the assistance of an LLM.

In another example, the user may be looking to generally identify great unmet needs to be solved by innovations. In this case, great unmet needs are plural and not singular, so the strategic innovation system 100 may be constantly updated with respect to the identity of the great unmet needs. And, at any time during that process, the user may explore tangents, such as inquiring about market sizing information, patent information, what the criteria may be derived for a user, a customer, a decision maker, a payer, a patient, an anchor stakeholder, a beneficiary, etc.

Because innovation is a multi-stakeholder ecosystem, a need in a population and an outcome to be solved by a specific solution may be needed to create value. Advantageously, the strategic innovation system 100 is flexible with many constantly changing variables that may be involved to determine whether the solution has met the goal – which may be dynamic and open ended.

In a product development example, after the best need and the best solution to that need is proposed, the product is launched in the market and receives constant feedback based on whether the product performance is acceptable. If not, strategic innovation process may be refined, from the need, to the solution, to the solution performance criteria, to stakeholder criteria, etc.

Due to the constantly changing timelines and market conditions of the world, the goal is really never fixed but always changing. The strategic innovation system 100 advantageously optimizes each of the steps of the innovation process to produce the best innovation.

### Additional Features of the Strategic Innovation System 100

There are several additional features that are incorporated into the strategic innovation system 100.

In certain embodiments, contextual information used by the strategic innovation system may be stored and processed as a time-indexed sequence of contextual elements rather than a strictly static or stateless conversation history. Each contextual element—including user inputs, agent outputs, retrieved research materials, summaries, intermediate artifacts, or system-generated insights—may be associated with temporal metadata such as timestamps, interaction counts, modification history, and relevance indicators. When constructing prompts for stateless LLM interactions, the system may dynamically select and weight contextual elements based on one or more temporal or interaction-based criteria. For example, the system may prioritize recent contextual elements, alternatively prioritize earlier foundational context, or combine both through configurable weighting functions. Users may explicitly configure how temporal context influences relevance, such as specifying that more recent interactions carry higher priority, that frequently referenced context elements are weighted more strongly, or that foundational context elements retain persistent importance regardless of age.

The strategic innovation system 100 includes context-based retrieval-augmented generation (RAG), which uses previous context (such as a context chain from parent to starting node) to optimize query for RAG.

In addition to temporal ordering, contextual elements may be ranked using one or more relevance metrics including semantic similarity, interaction frequency, inferred importance, user-defined weighting, or agent-generated evaluation scores. One or more agents may analyze contextual elements and assign relative importance scores indicating the degree to which such context should influence downstream reasoning. For example, contextual information derived from authoritative sources such as highly cited scientific publications or validated datasets may be assigned greater weight than lower confidence sources. Similarly, contextual elements referenced repeatedly across multiple agents or interactions may be automatically elevated in importance. In certain embodiments, the system may allow users to manually override these rankings, thereby enabling human judgment to influence how context is prioritized when constructing prompts for downstream agents.

In certain embodiments, contextual selection operations may further include computational optimization mechanisms configured to reduce contextual payload size transmitted to downstream inference systems. For example, the system may selectively exclude low-relevance contextual segments, compress contextual summaries, prioritize dependency-linked contextual elements, or dynamically construct reduced contextual representations based on downstream execution objectives. Such selective contextual construction mechanisms may reduce memory utilization, reduce token consumption, and improve inference efficiency across stateless inference architectures.

The strategic innovation system 100 allows the user to re-arrange context or use any agent output as context to any agent, and update output along each chain of agents.

An agent has a dependency tree, and as long as its dependency is satisfied along its ancestors in the dependency tree, the agent is enabled.

An agent may ask users for input if the data is not in its dependency tree.

An agent may auto-suggest another agent to resolve input dependency.

In certain embodiments, multiple candidate agents configured to satisfy the same input dependencies may be executed concurrently in order to generate a diverse set of outputs. The system may subsequently evaluate the outputs produced by these agents using ranking criteria, clustering methods, semantic similarity analysis (using a threshold condition), or user-defined evaluation metrics. Based on these evaluations, the system may present a filtered set of candidate outputs to the user or automatically select the most promising outputs for further downstream processing.

An agent may have the following properties:
1:1 The agent takes one input and generates one output (e.g., Need Statement Format Verification);
1:n The agent takes one input and generates an array of outputs (e.g., Where to Observe);
N:1 The agent takes many inputs and generates one output (e.g., Interview Organizer finds common themes among all interviews);
N:n The agent takes a number of inputs and generates a number of outputs, (e.g., Categories of Interest identifies constraints that lead to categories of interest or RAG, many articles leads to many needs).

Some inputs are human-defined inputs, while other inputs may be suggested by an agent (e.g., finding needs and having the agent perform a Pubmed search).

In some embodiments, contextual elements within the strategic innovation system may be stored as nodes within a time-aware knowledge graph or similar relational structure. Each contextual element may include attributes describing when the information was generated, which agents produced it, how frequently it has been referenced, and which downstream nodes depend upon it. By representing context as a temporally annotated graph rather than a linear message history, the system may selectively retrieve context based on recency, dependency relationships, semantic similarity, or relevance to the current agent’s objective. This enables efficient prompt construction even in large workflows where extensive contextual history exists.

As noted above, each node of the strategic innovation system 100 may be linked to any node, which allows the context to be passed at any step of the process. The strategic innovation system 100 may call on separate LLMs to run each of the steps, and the user may inject context arbitrarily to affect the outcome of that agent to, in a sense, create parallel universities of output.

For example, an agent (or workflow submodule) that identifies needs from literature may input an array of text and then generate an array of needs. In some embodiments, an agent may be accessed from different flows even outside of the strategic innovation system 100. If the output of one bot is at least a singular need, and the input from a different bot is at least a singular need, then the bot can activate to function.

Other use cases may also use the same framework for different global goals. For example, instead of a strategic innovation system, the framework described here could also be used as a dynamic and flexible framework to do many additional process steps and or objectives such as but not limited to: Cross-functional Research and Development Portfolio Optimization Reports, Business Model Pivoting Blueprints and Market Intelligence Business Strategy Recommendations, Intelligent Regulatory Change Impact Assessments, Geo-strategic Market Entry Risk Profiles and Reports, Ethical Foresight Analysis Documents, FMEA (Failure Modes and Effects Analysis), RCA (root cause analysis), Lean Canvas / Lean Startup optimized business strategy, Sustainability-Driven Product Lifecycle Frameworks, Organizational Change Playbooks, Legal Argumentation Strategy Modeling for Case Success Prediction and Recommendations, Strategic Investment Decision Frameworks with Scenario-based Growth Modeling, Venture Capital and Angel Scenario Investment Decision Support and Investment Thesis Creation and Analysis, Dynamic Operational Efficiency Blueprints Integrating Real-time Supply Chain and Policy Variables, Adaptive Supply Chain Logistics Optimization Based on Geopolitical, Environmental, and Economic Factors, and many more complex processes where complex multi-variable decision making frameworks are required to not only reach the optimum answer but also define what optimum answers and options thereof may or may not be available to a user or system looking to define and or optimize these respectively.

It should also be noted that all data, databases, information, user inputs, system inputs, system data sharing and processing, etc. may occur not just as text but also as images, audio, video, diagrams, sensor data, geospatial data, biometric signals, structured datasets, natural language, time-series data, behavioral telemetry, haptic feedback, motion capture streams, and any combination thereof, whether captured live, pre-recorded, synthesized, AI-generated, or retrieved from external or internal systems.

### Example GUIs for the Strategic Innovation System 100

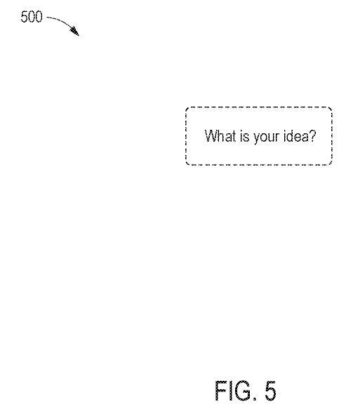

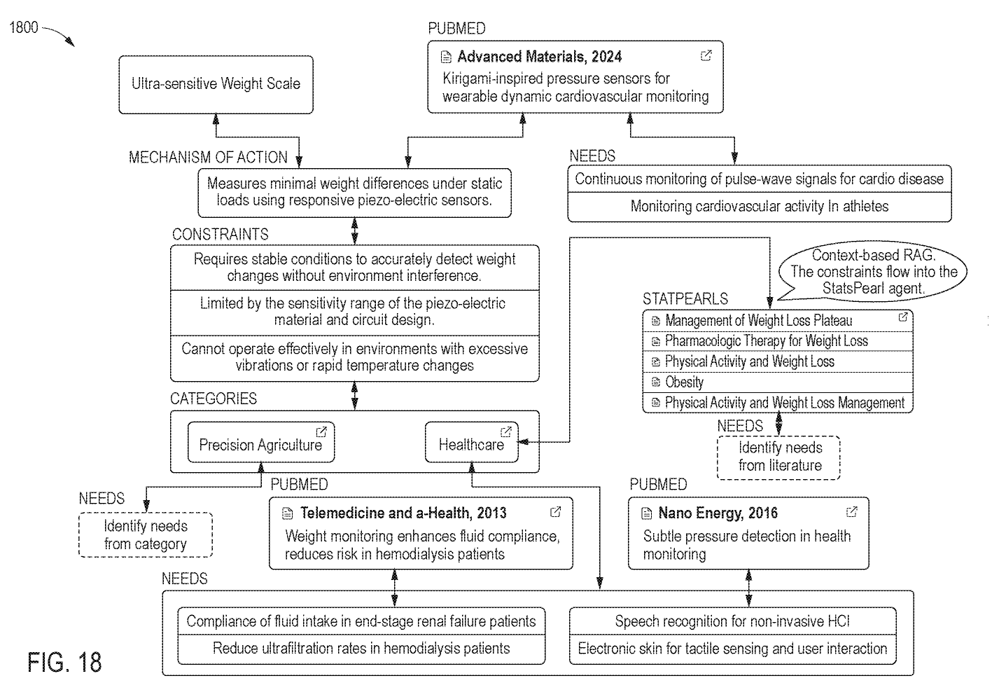

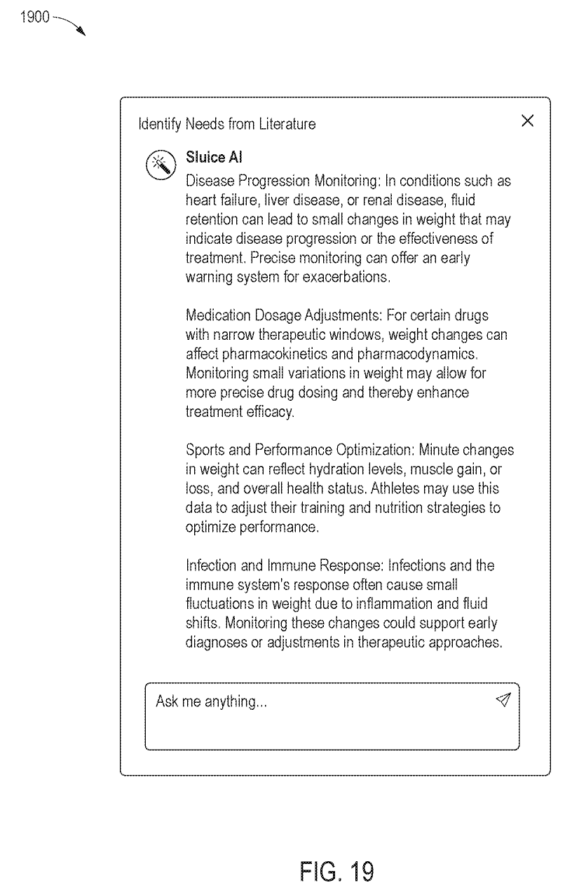

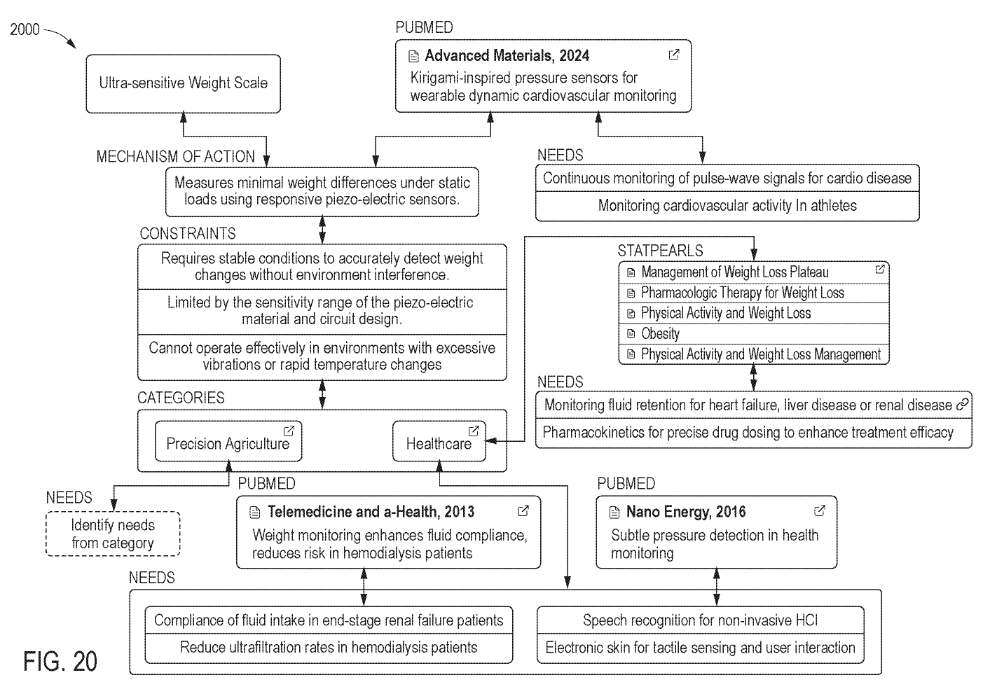

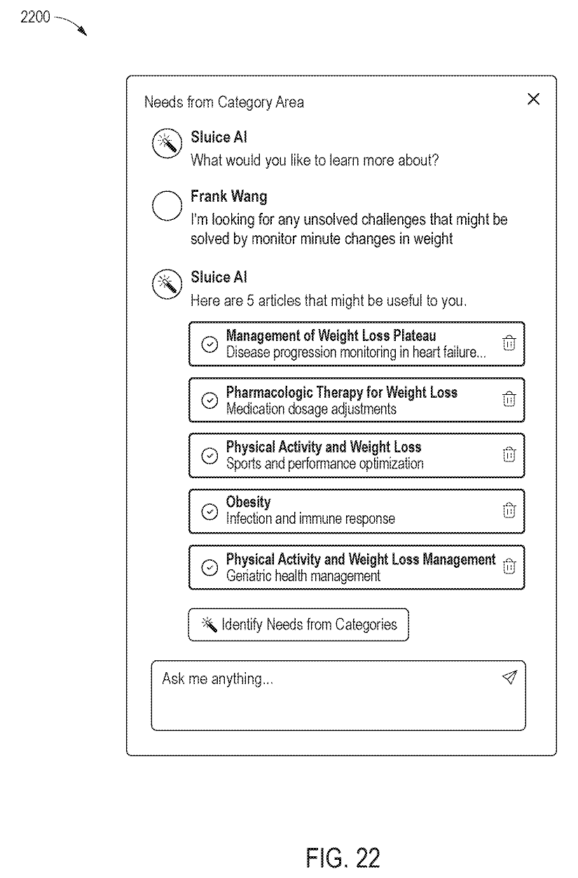

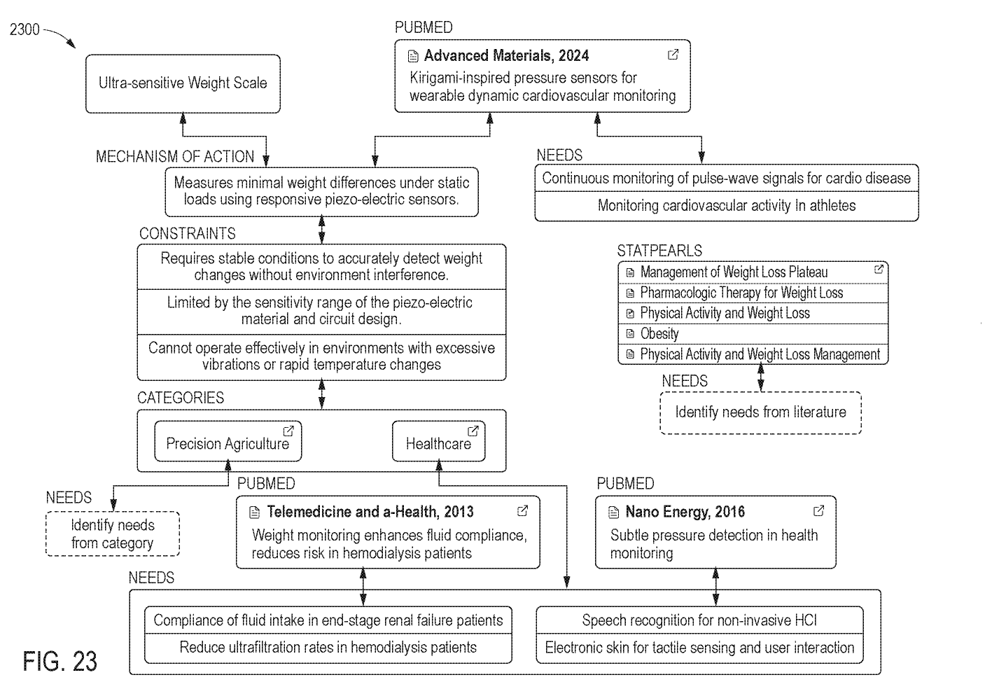

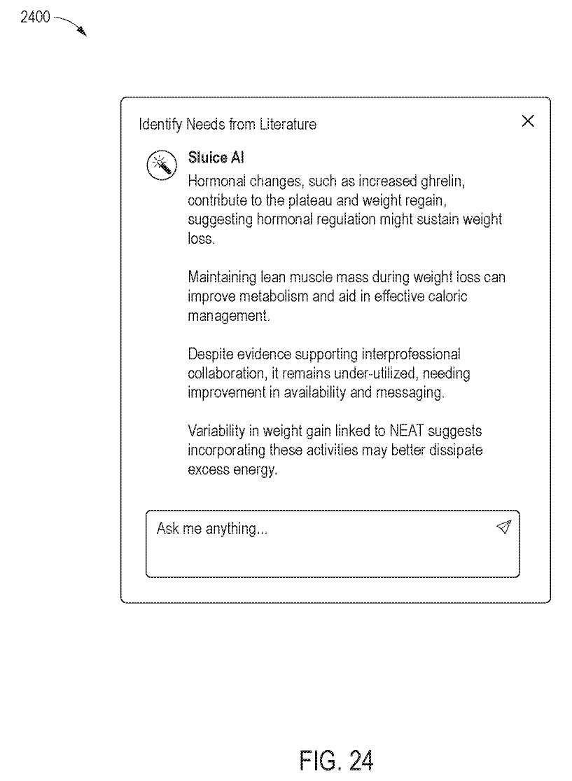

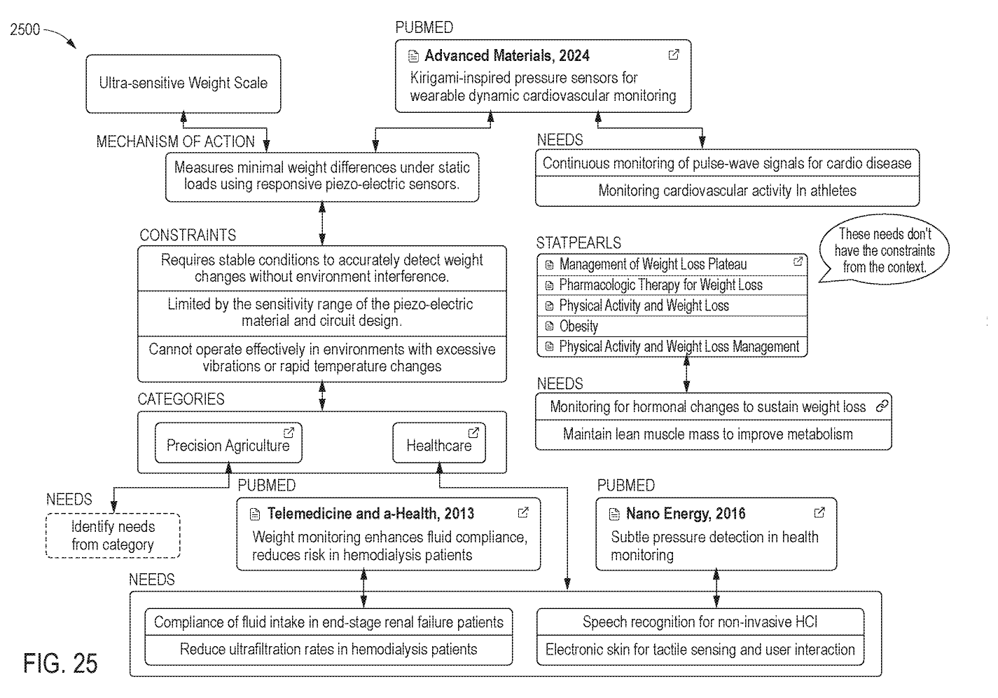

FIGS. 5–40 depict example GUIs associated with the strategic innovation system 100, in accordance with embodiment of the present disclosure.

FIG. 5 depicts GUI 500, in accordance with embodiments of the present disclosure. GUI 500 is the starting point for a new workflow. User would double click to open the pop-up.

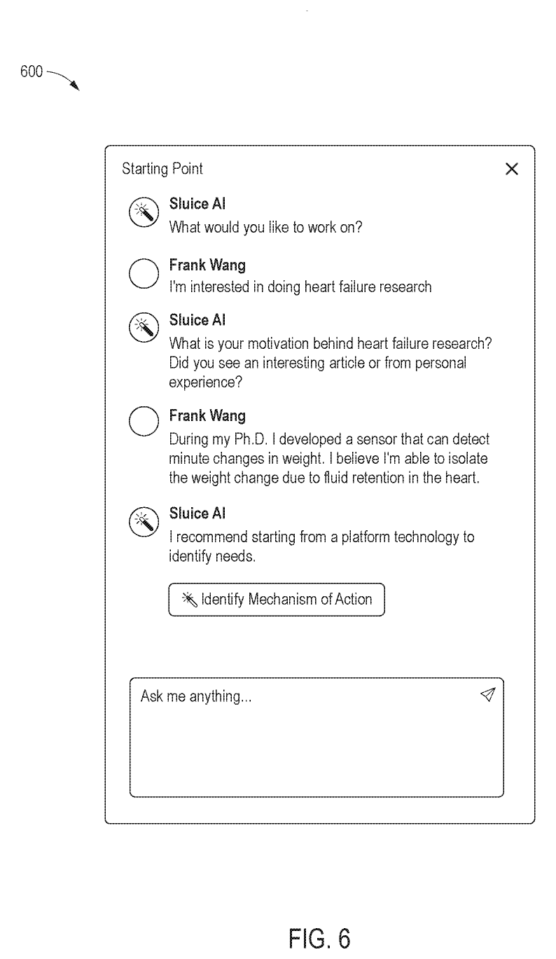

FIG. 6 depicts GUI 600, in accordance with embodiments of the present disclosure. GUI 600 is a pop-up “Starting Point” which provides the user with guidance and options as to what activities they may want to proceed with. User can chat with the AI to get additional guidance on what options may be best for their scenario. The chatbot would identify specific sub-modules (individual tools) that are attached to the scenario as children to the current initial node which should help. The user can click on each of the tools to then directly open up the tool and proceed through the further instructions OR they can close the current tool and view the flowgraph with how the system and or prior user interaction has suggests the flow should proceed.

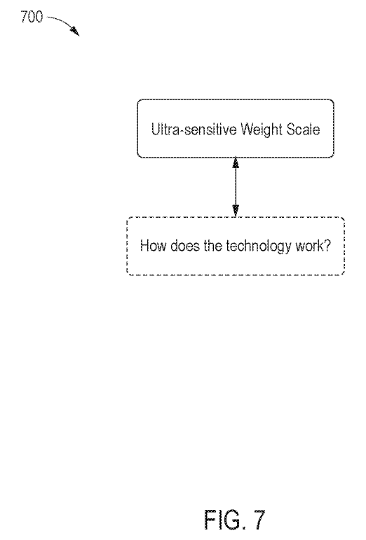

FIG. 7 depicts GUI 700, in accordance with embodiments of the present disclosure. GUI 700 is a flowgraph that is demonstrated if the user closes the pop-up. The user can click on the next node “How does the technology work?” to engage and follow further instructions / interact with the next parts of the system and complete the tasks/goal of that node.

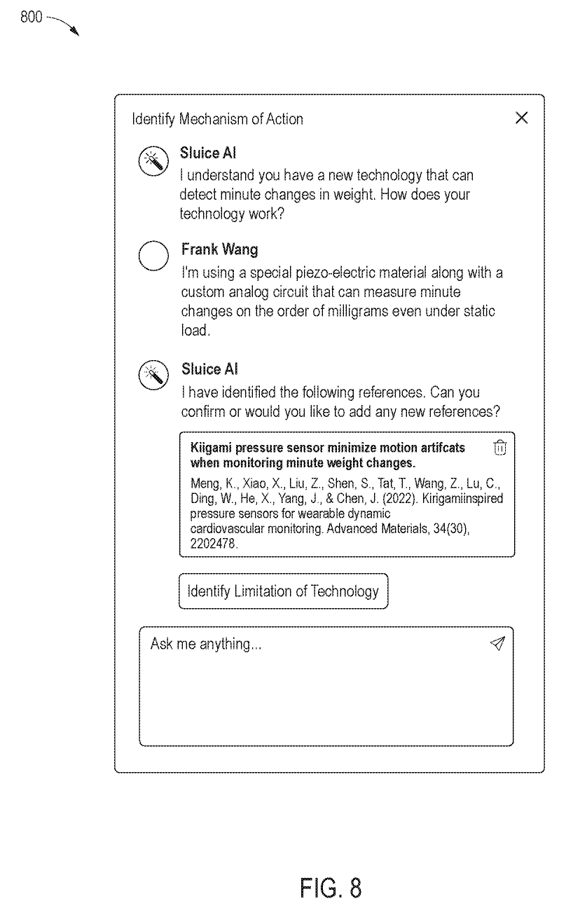

FIG. 8 depicts GUI 800, in accordance with embodiments of the present disclosure. GUI 800 is an Identify Mechanism of Action – Pop Up – of the next node in the flow graph with further instructions and areas where the user can interact. If the user clicks on the node directly from the previous pop up they would go to this view – which continues the chat that the user will have but it allows the user to jump into any of the different nodes as a larger flowgraph is built so they can converse with that specific node’s instructional AI. This pop up will have the context of all the previous parent nodes that came before it in the flow. The benefit of the flowgraph is that a user can not only build from one to another but can enter back in the middle of the flow if new context for a middle flow sub-module needs to be adjusted or additional information is inserted to that – allowing a cascading change to downstream nodes if desired by the user.

In this current node it is identifying the mechanism of action but the system is missing context it needs to complete the task. Therefore it automatically identified an external resource that it can use to help complete the task. User’s can also add additional resources if desired in the chat or directly on the flow graph and then connect them to this node (i.e a separate database, files, vector store, etc.). This allows the user to click this block and then the system can work to identify the limitations of the technology that would be important context for the next steps.

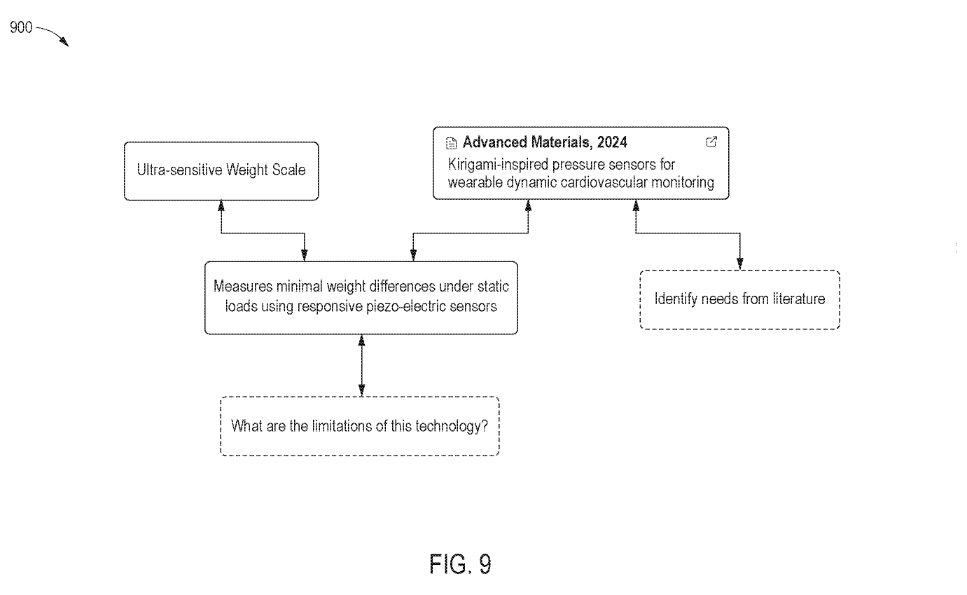

FIG. 9 depicts GUI 900, in accordance with embodiments of the present disclosure. GUI 900 is a flow graph representing additional nodes that have been added throughout the system where the user started with an idea of an ultra-sensitive weight scale. Then the system has identified the paper “Advanced Materials, 2024” as context input from automated search sub-module that can provide input context in similarity to the idea entered by the user. What we are trying to demonstrate with this page is that additional modules are activated automatically when the input is satisfied. All modules are constantly looking for inputs – when that input is satisfied that is when the system knows to enable that node and then act on the instructions of that node to take further actions such as gathering more context. This can also be configured to allow the users to choose to enable the node or not and or automatically enable it depending on configured settings and preferences of the user.

Each sub modules have required inputs and optional inputs. For identify needs from literature it must have a literature source as an input as one example. Whereas – in this example the “minimal weight difference” as a mechanism of the technology was found because an optional find literature from external resources feature was enabled but the user had to confirm that information should be added.

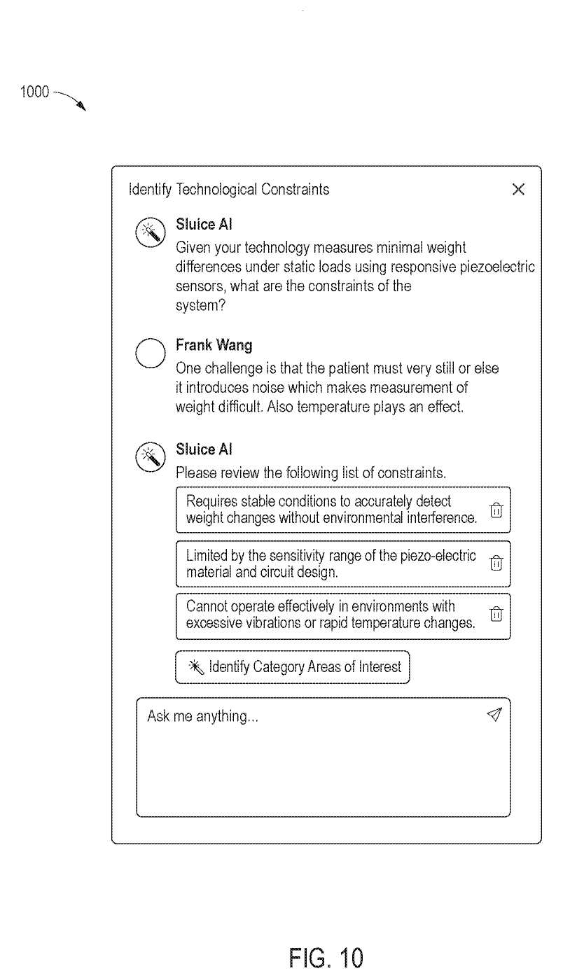

FIG. 10 depicts GUI 1000, in accordance with embodiments of the present disclosure. GUI 1000 is an Identify Technology Constraints pop up – in the next step in the flowgraph this pop up appears which can help the user identify the constraints of the technology. The output of this node is constraints for the system. The GUI allows the user to edit the constraints identified by the system and then all subsequent children/sub-nodes can use these constraints as further input.

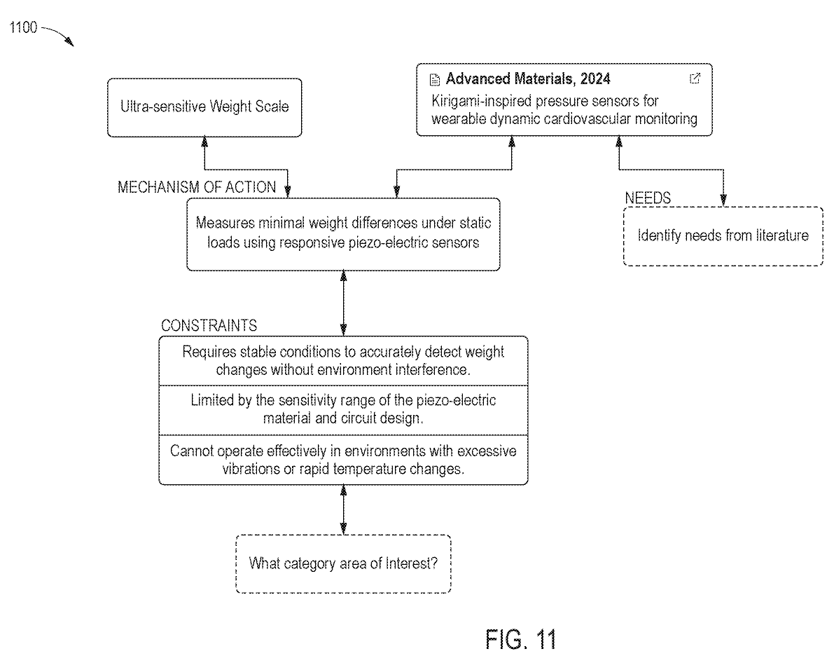

FIG. 11 depicts GUI 1100, in accordance with embodiments of the present disclosure. GUI 1100 is a flow graph – the user interface for an array can either be grouped or separate. In this example the constraints are grouped together so that the constraints go all together for the following node. In subsequent examples we will show where the output is individualized vs grouped outputs entered into subsequent nodes.

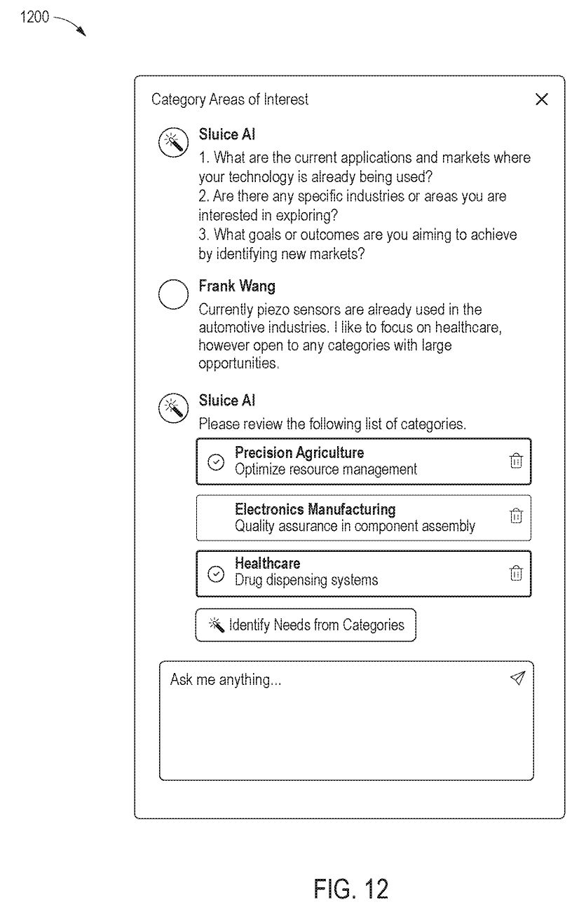

FIG. 12 depicts GUI 1200, in accordance with embodiments of the present disclosure. GUI 1200 is a Pop Up Category Areas of Interest – This does a similar thing where it allows user to select the categories that they care about. Note this functionality is like the other modules a capability that user’s can perform when more information is presented – allowing the user to curate what is used or not used in sub-modules.

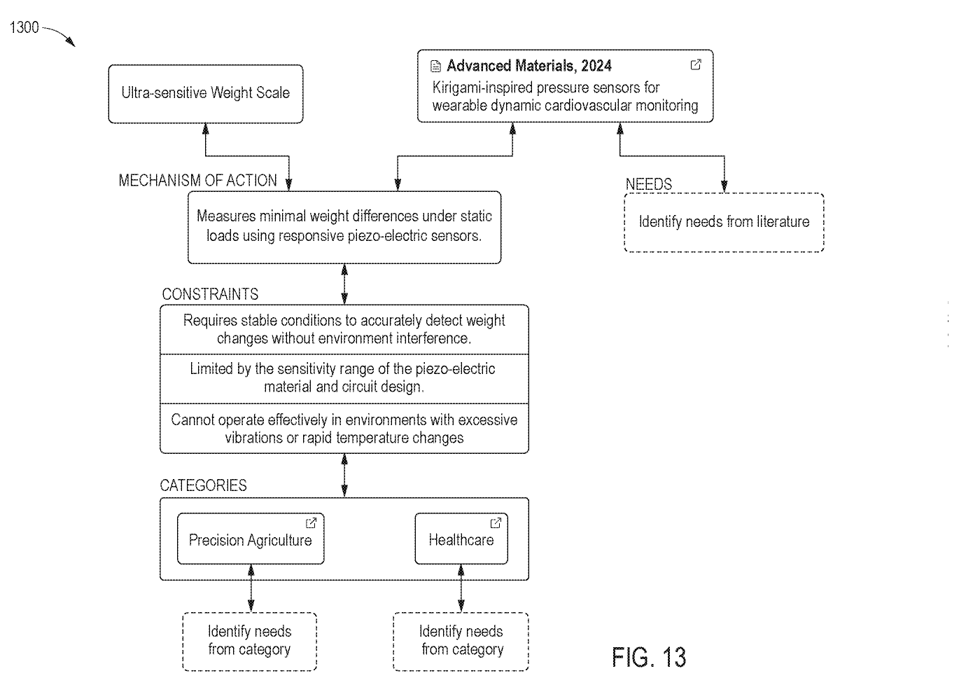

FIG. 13 depicts GUI 1300, in accordance with embodiments of the present disclosure. GUI 1300 is a flow graph –instead of grouping it is now separate categories. The choice to group or separate can be done by the system per the specific situation and instructions or can be manually done by the user (and the reverse also true). It shows that the category areas each of these are separate – they now have individual children nodes below them to identify needs for those specific categories. Note that there is still only one node for Categories – a node doesn’t automatically branch to two nodes. We have a chat that is leading to Categories which includes precision agriculture and healthcare – but then from there the user can go down the chain in one of those or both of those categories independently. User can click on any of the pop-up icons to create a new document so that the user doesn’t clutter the main flow. Clicking on the arrow pop up icon for healthcare allows a new document to be created with healthcare but that new document can include the prior context from this original parent flow from the healthcare node up the chain – all the way up to ultrasensitive weight scale which started this flow. Pop ups allow you to expand into tangent areas at any point of the chain where this capability exists. The database structure is each of the nodes have a document assigned to it and X Y coordinates so there is no concept of documents but only for GUI display.

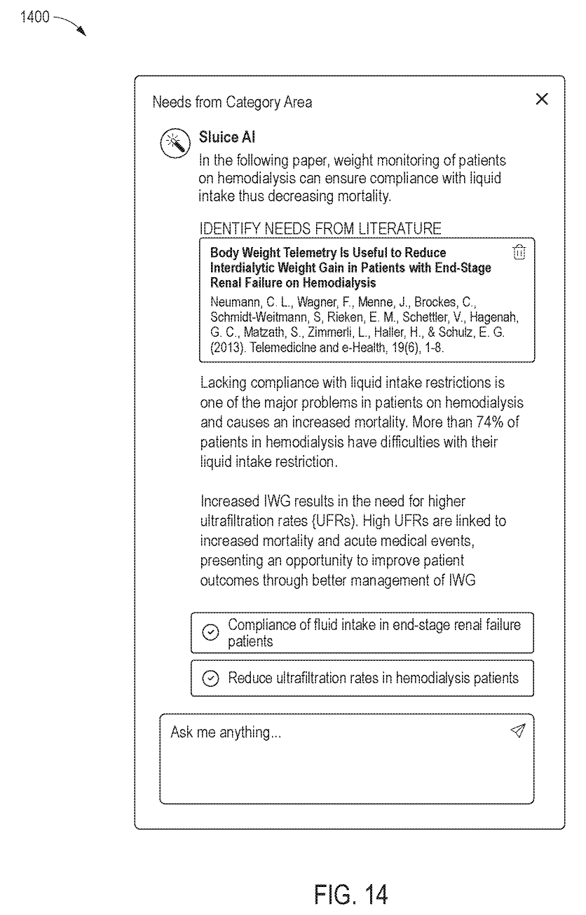

FIG. 14 depicts GUI 1400, in accordance with embodiments of the present disclosure. GUI 1400 is a Pop-Up Needs from Category Area – The goal has been met (identified by the green) – the goal of this module is to identify one or multiple needs and then when the system meets that goal it flags them for the user. This also becomes the output of this module which can serve as input to another module, such as identifying populations and or outcomes of interest, solutions, etc. The goal is to complete the innovation process in a stepwise fashion with inputs, outputs, and goals of differing modules being used, activated, deactivated, grouped, or split as desired – and each module can be tailored to the user’s or corporate goals which may be different from each other and or different situation to situation.

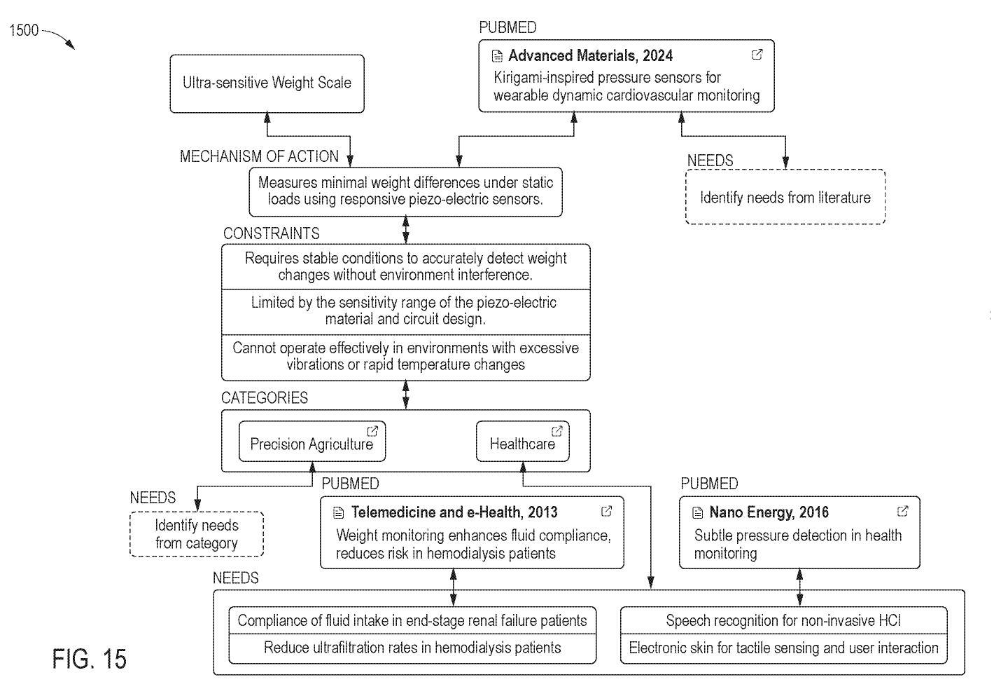

FIG. 15 depicts GUI 1500, in accordance with embodiments of the present disclosure. GUI 1500 is a flow graph – shows the output of the completed flow graph where the module has met the goal – in this case to identify the needs. It identified multiple papers with multiple needs and context and created new nodes as a result to help the user think more laterally or disruptively.

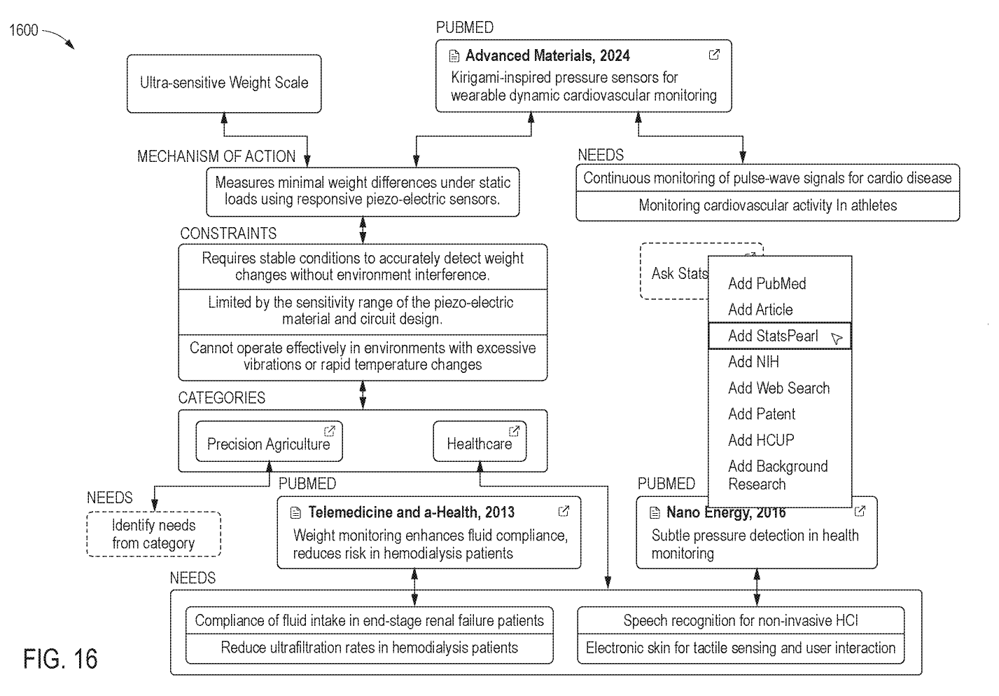

FIG. 16 depicts GUI 1600, in accordance with embodiments of the present disclosure. GUI 1600 is a flow graph – In this flow graph we demonstrate that the user will want to add a node that the system didn’t originally recommend. So you can see on the right where the user can insert an “add stat pearl” node which the system can now call based on the user input. The user can right click and then pick where the node is going to be within the flow and the user can drag and or connect the node into the flow where they want it to go.

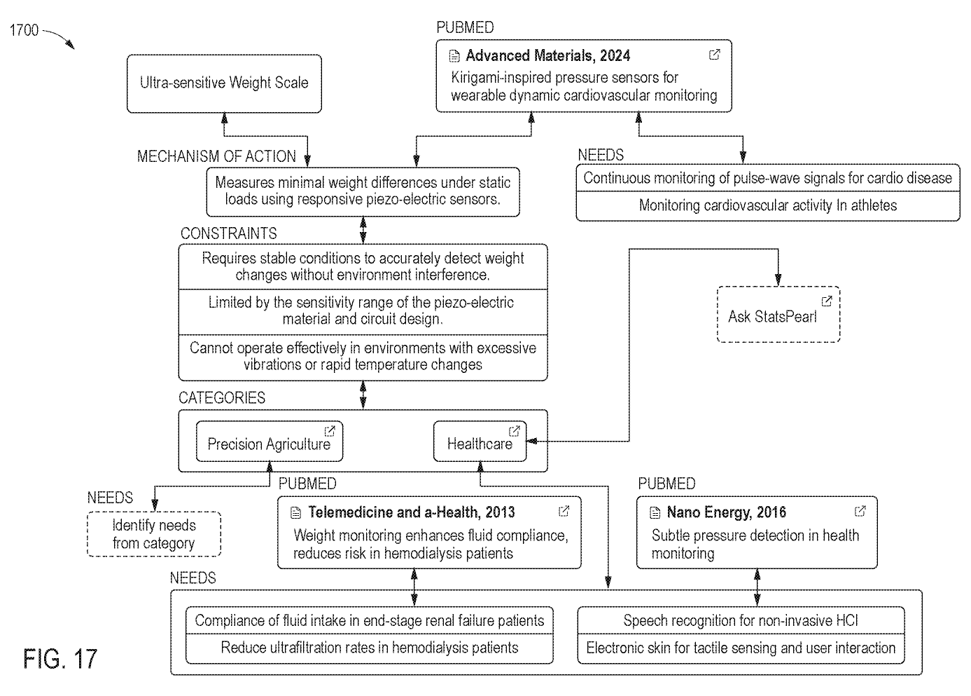

FIGS. 17–20 depicts GUIs 1700, 1800, 1900, 2000 (respectively), in accordance with embodiments of the present disclosure. GUIs 1700, 1800, 1900, 2000 depict when the new node is connected to the previous flow.

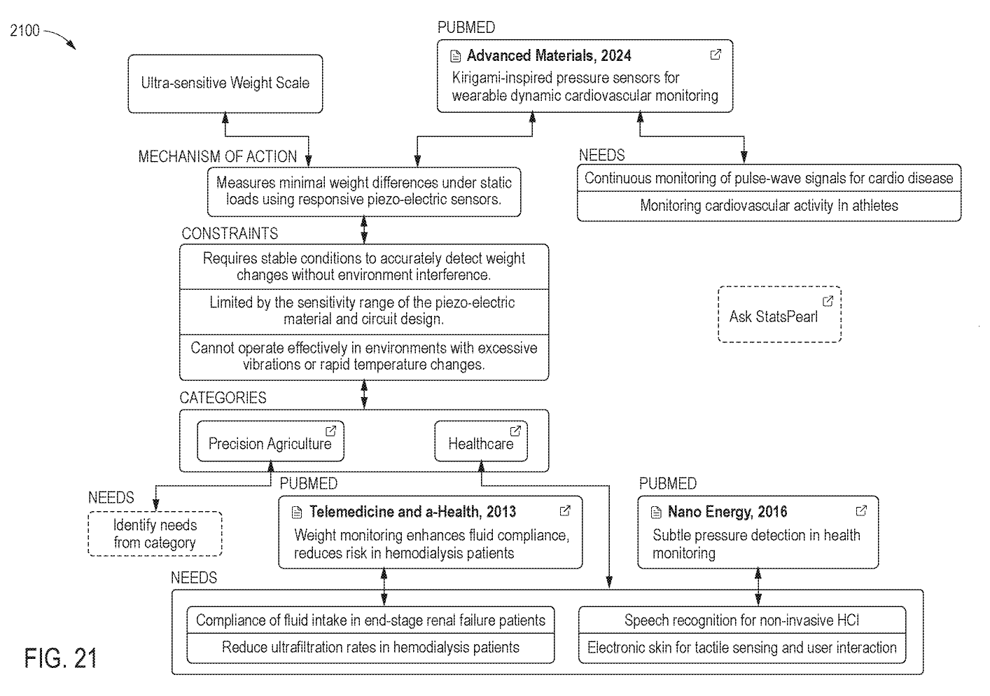

FIGS. 21–25 depicts GUIs 2100, 2200, 2300, 2400, 2500 (respectively), in accordance with embodiments of the present disclosure. GUIs 2100, 2200, 2300, 2400, 2500 depict when the new node is not connected to the previous flow.

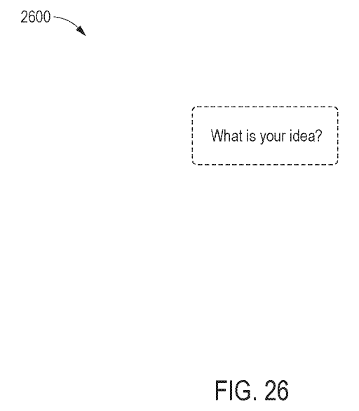

FIG. 26 depicts GUI 2600, in accordance with embodiments of the present disclosure. GUI 2600 is a flowgraph – for a new flow starting based on idea.

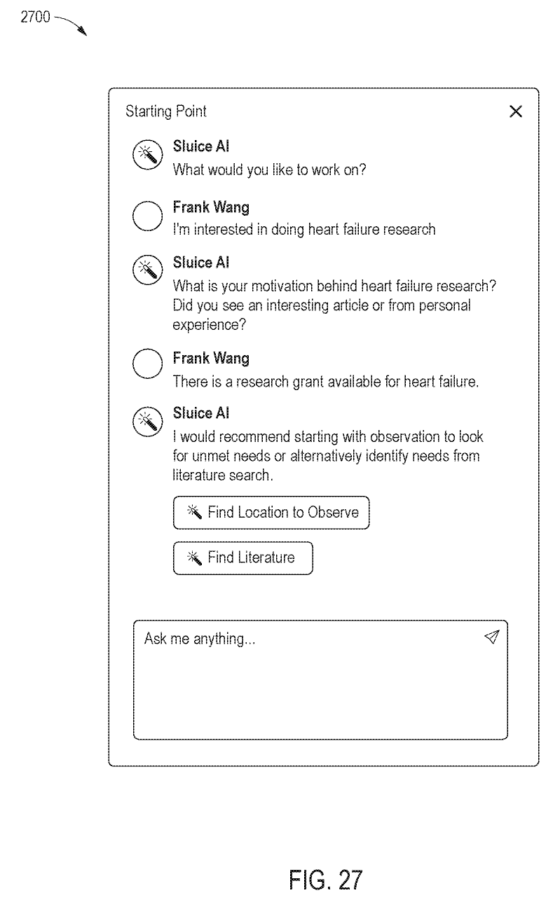

FIG. 27 depicts GUI 2700, in accordance with embodiments of the present disclosure. GUI 2700 is a Pop-out – same flow as previous but this time the user and bot interaction has identified a different flow from the conversation with the user. In this case it’s guiding the user to use observations and literature tools to advance as the next step.

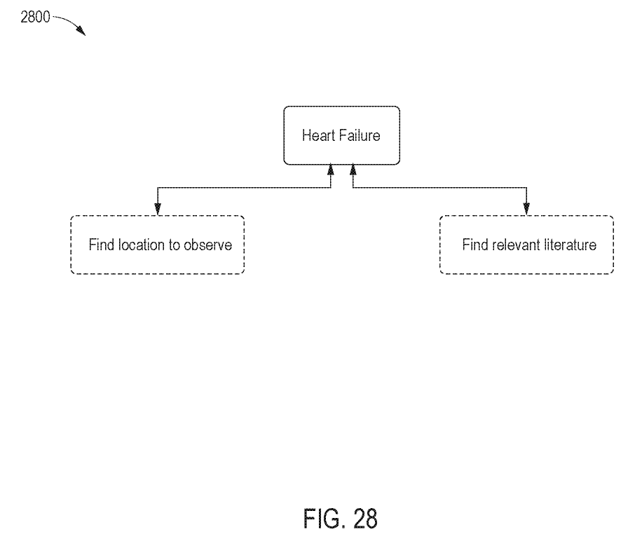

FIG. 28 depicts GUI 2800, in accordance with embodiments of the present disclosure. GUI 2800 is a flowgraph - Heart failure is identified as the starting category and the user has two modules to advance from with observations and literature search as two categories.

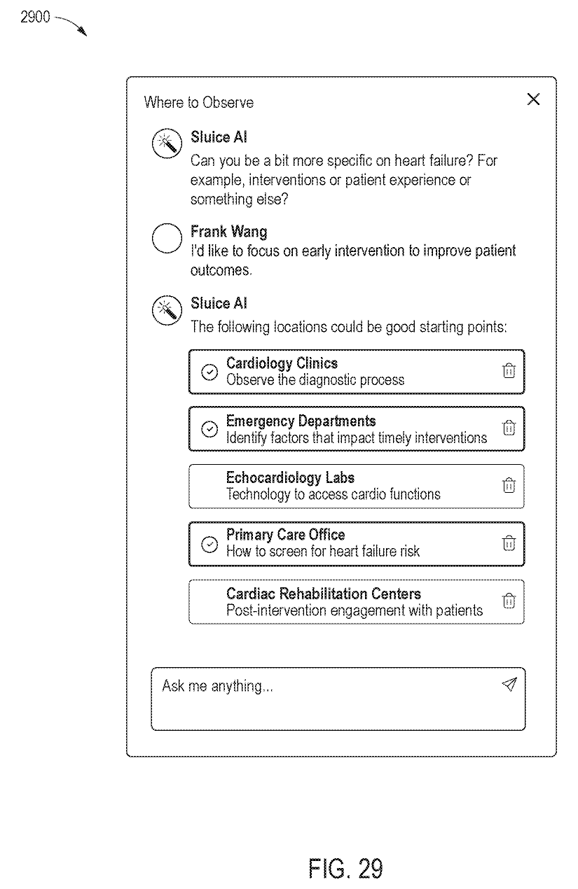

FIG. 29 depicts GUI 2900, in accordance with embodiments of the present disclosure. GUI 2900 is a Pop up – Demonstrating per previous but with the new flow of where to observe and the user can select or delete recommendations made by the system.

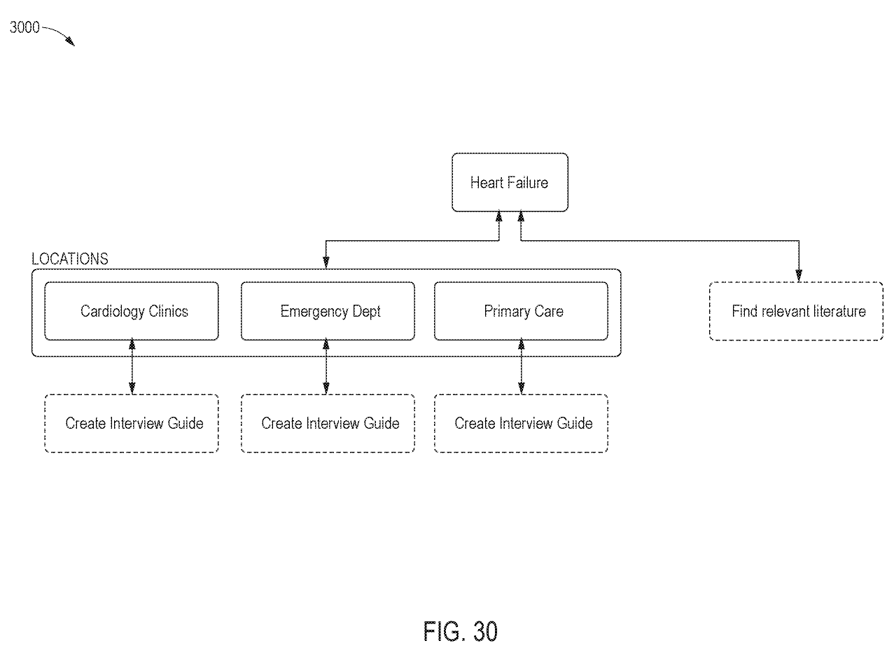

FIG. 30 depicts GUI 3000, in accordance with embodiments of the present disclosure. GUI 3000 is a flow graph – just showing that the outputs are not grouped and each output could trigger a new node

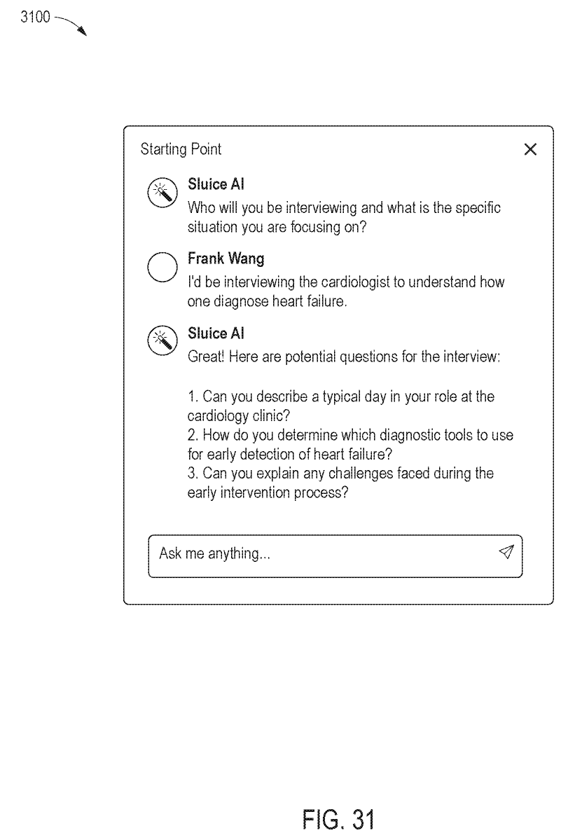

FIG. 31 depicts GUI 3100, in accordance with embodiments of the present disclosure. GUI 3100 is a Pop up – shows interview guide triggered for one of the nodes from Page 26

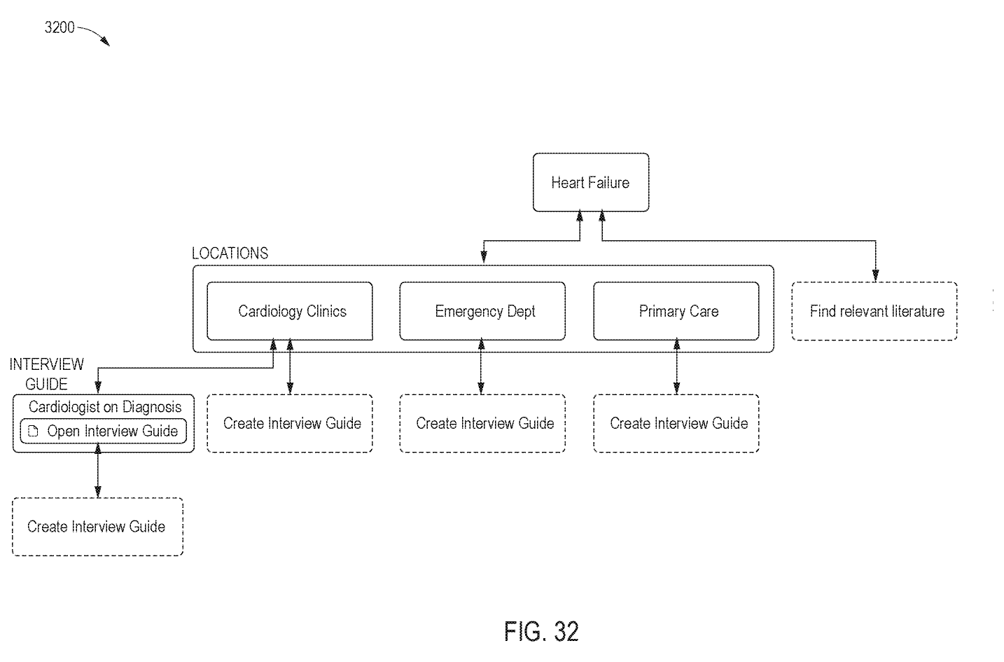

FIG. 32 depicts GUI 3200, in accordance with embodiments of the present disclosure. GUI 3200 is a flowgraph – here showing how the user interface works to view the output of a node to click the button within the node to view the actual interview guide – clicking the actual node opens the chat pop up (different action).

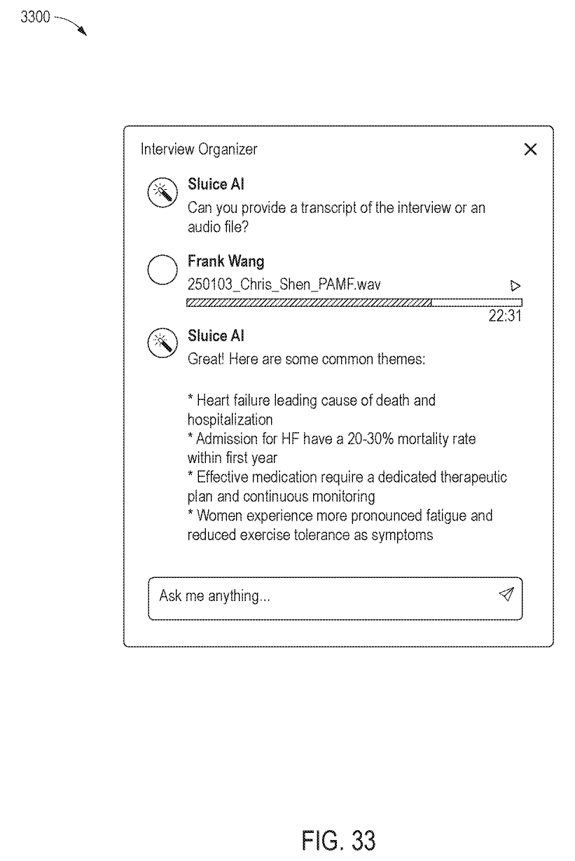

FIG. 33 depicts GUI 3300, in accordance with embodiments of the present disclosure. GUI 3300 is a Pop up – this one is to organize interview that he user may have had – including from audio recordings and or visual files or other multi-modal inputs.

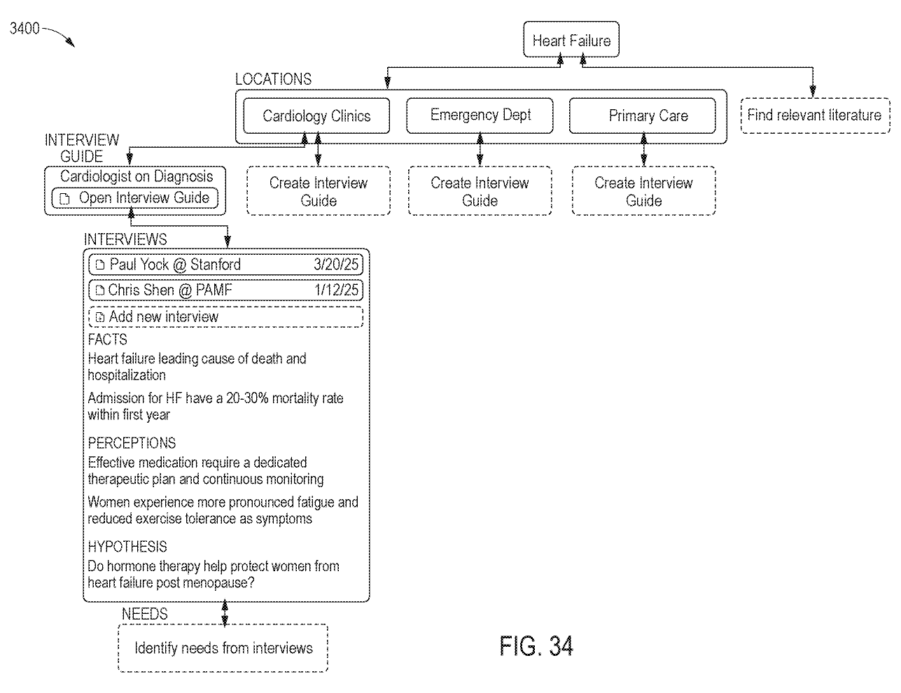

FIG. 34 depicts GUI 3400, in accordance with embodiments of the present disclosure. GUI 3400 is a flowgraph – to create additional array of inputs. This is how we would do an array of inputs to this node. This node organizes multiple interviews and this is the interface to add multiple interviews to this node. Double clicking each of the inputs will bring up the pop up associated with that conversation.

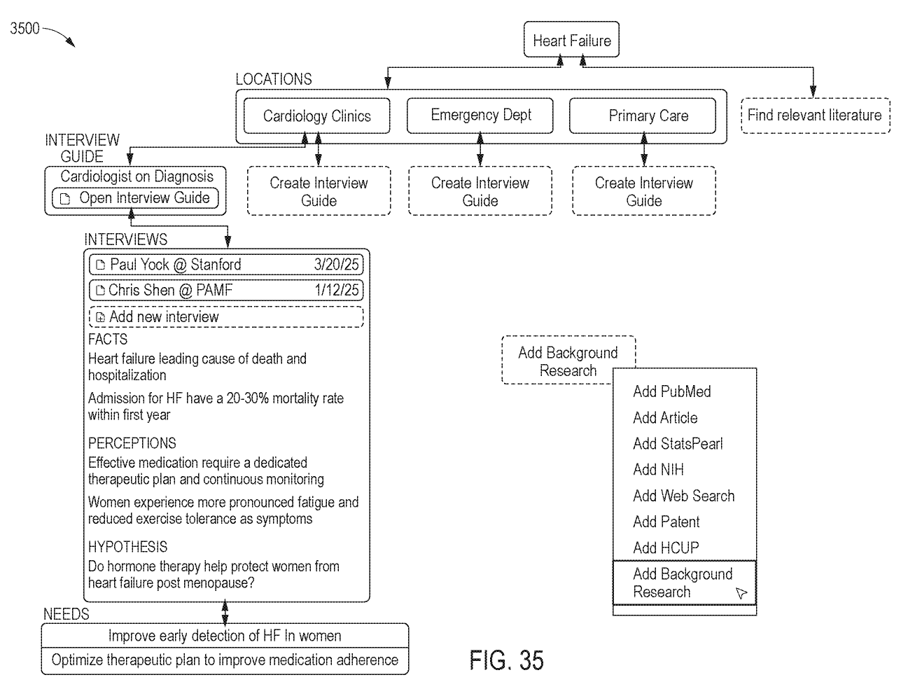

FIG. 35 depicts GUI 3500, in accordance with embodiments of the present disclosure. GUI 3500 is a flow graph – showing the output has been completed for that flow when you click on identify needs from interviews. Also to show you can add background research as another node.

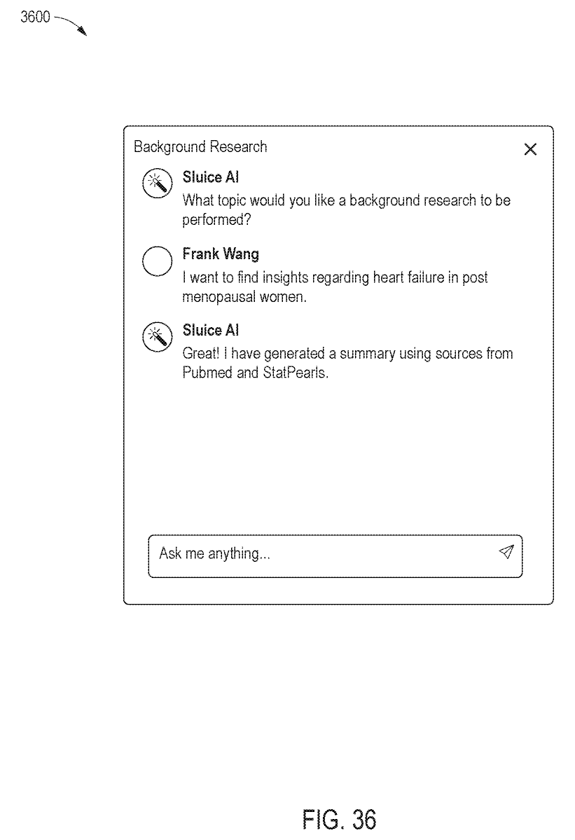

FIG. 36 depicts GUI 3600, in accordance with embodiments of the present disclosure. GUI 3600 is a Pop up – interacting with the Background research bot to then identify articles and sources to support information. Helps to auto-generate a Wikipedia or summary article deep research equivalent with the context.

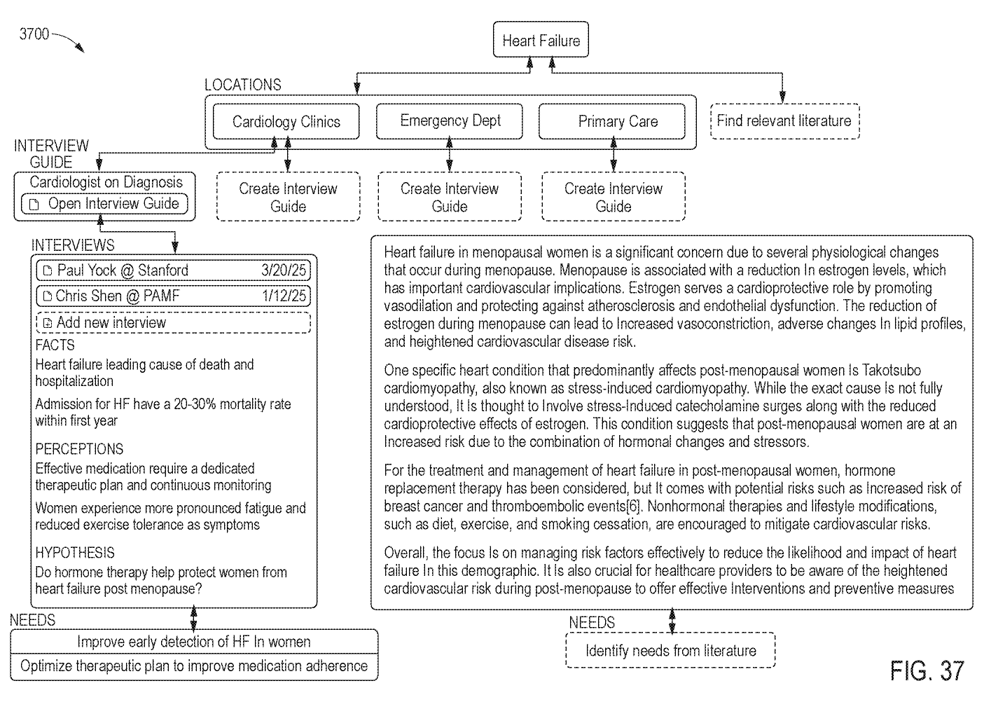

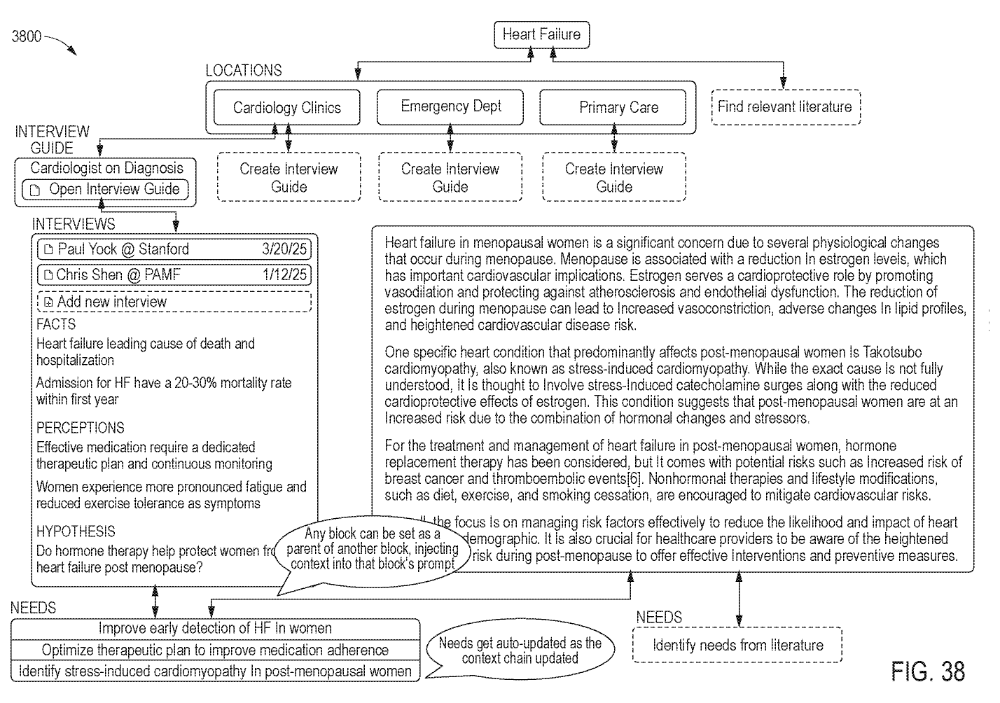

FIGS. 37 and 38 depicts GUIs 3700 and 3800, in accordance with embodiments of the present disclosure. GUIs 3700 and 3800 are flowgraphs – background research node can be sent as a parent to identify needs from interview by the user (i.e. can be inserted in a higher place in the flow mid-stream) – that can automatically change what the downstream needs are that were generated from the interview. Note that we can also track the historical needs and able to show what has been presented previously for the user to keep or discard.

The idea is if you talk to one person and they mention one need area – but the user doesn’t have any background then the user can ask the system to add more research background and use that as context to help the system generate and identify more interesting needs after further research is done with the same initial interview. In some embodiments, the system may further enhance the GUI workflows (e.g., GUI 3500, 3600, 3700, 3800) by incorporating team-based, tenant-aware functionality that enables collaboration, insight discovery, and organizational knowledge sharing. For example, within a shared enterprise or multi-team workspace, the system may surface latent insights or hidden patterns derived from interviews, background research, or need statements generated by other users or teams within the same tenant organization. This may include proactively identifying overlapping problem spaces, complementary skill sets, or adjacent innovation themes across otherwise siloed teams. The system may also suggest potential cross-functional collaborations or highlight previously disconnected projects that show conceptual, strategic, or technical alignment. Furthermore, historical outputs—such as previously generated needs, discarded ideas, and intermediate decision paths—may be contextually re-presented to users as a form of organizational memory, enabling informed iteration, reuse, or challenge of prior assumptions. These capabilities may be powered by semantic indexing, graph-based similarity analysis, or persona-informed clustering to detect nuanced relationships across users, projects, and content. This enhanced GUI-driven approach thus transforms individual innovation workflows into a broader collaborative intelligence layer across the organization, amplifying the strategic value of each user interaction.

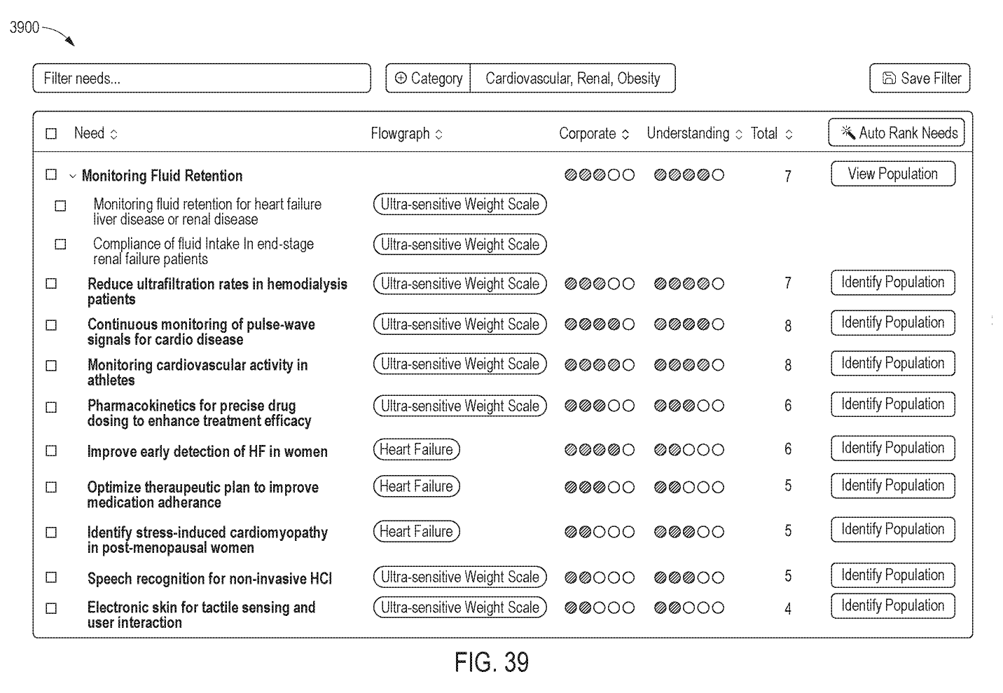

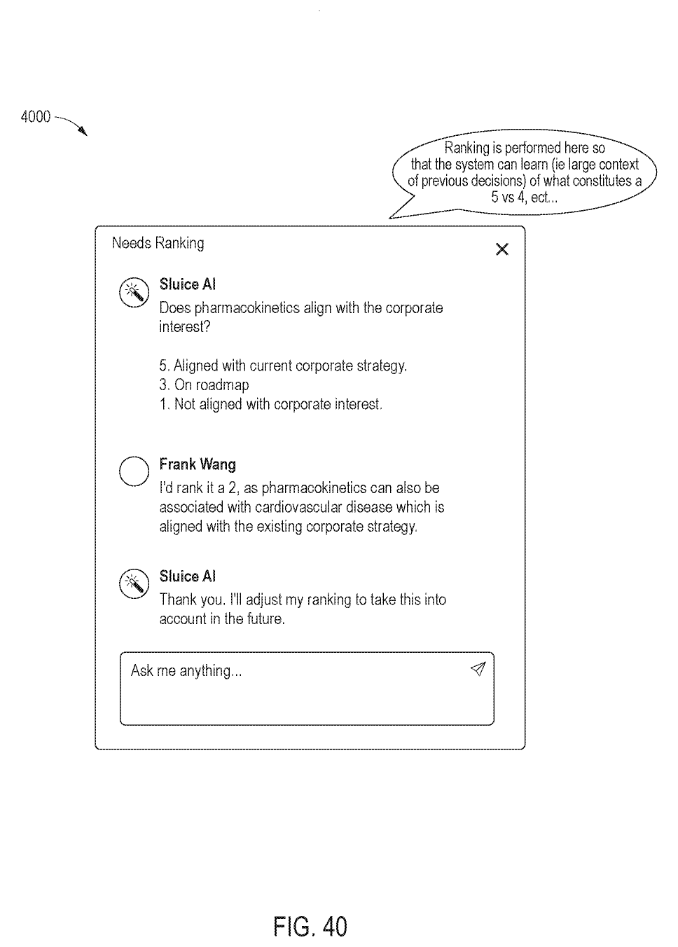

FIGS. 39 and 40 depicts GUIs 3900 and 4000, in accordance with embodiments of the present disclosure. GUI 3900 is a Table and GUI 40 is a Pop up. With respect to GUI 3900, each of the output green bubbles becomes a line item on the list which the users can evaluate and review through filtering and prioritization matrix. The list may have its own chatbot(s) / AI system which allows it to learn the ranking preferences of the users. This is outside of the nodes and other flowgraphs because if you are ranking in a unified page of all the outputs then the system can learn because it has the context and then apply that unified information it has across multiple needs to facilitate filtering in a more uniform way. In this page it can also group similar needs together such as monitoring fluid retention example shown there with the sub needs that are similar in different disease states. Also showing the chat interaction with the user. On the right hand side you can click auto-ranking needs. By clicking identify population it can create a new document in the next module that is linked back to this parent document.

The strategic innovation system may operate in multiple autonomy modes depending on configuration or user preference. In a fully autonomous mode, the system may automatically activate agents, retrieve contextual data, generate intermediate outputs, and refine solutions without requiring user intervention. In a semi-autonomous mode, the system may propose recommended actions or generated outputs that are presented to the user for approval before further processing occurs. In a guided mode, the system may provide suggestions, prompts, or recommended agent selections while the user retains primary control over workflow progression. In a manual mode, the user may explicitly control the invocation of individual agents, the selection of contextual inputs, and the sequencing of workflow modules.

In certain embodiments, the system may incorporate autonomous or semi-autonomous prompt generation capabilities. Specifically, one or more AI agents may generate, suggest, or insert custom prompts at various stages of the innovation workflow based on system-detected needs, tangents of interest, or task requirements aligned with the global goal. These prompts may be injected dynamically, without explicit user input, when the system determines that additional exploration, clarification, or redirection could improve output quality or accelerate progress. Additionally, the system may evaluate whether the current global goal remains optimal, and may recommend or autonomously revise the global goal in response to intermediate outputs—creating a feedback loop where downstream insights influence upstream objectives. These behaviors may be governed by configurable parameters defining the degree of autonomy allowed. Moreover, the system may track and learn from prior user selections, refinements, or overrides, enabling it to personalize prompt generation strategies over time. This allows the AI to increasingly align its actions with user preferences, decision styles, and strategic intent across sessions and contexts.

In certain embodiments, one or more GUIs may be configured to present a flowgraph including the nodes and edges representing dependency relationships between the nodes, and, in response to a user interaction, present a node-specific interface displaying (i) output generated by the first node and (ii) contextual inputs associated with one or more upstream nodes. The GUIs may also be configured to visually indicate, within the flowgraph, nodes affected by the detected change using one or more visual indicators comprising highlighting, color changes, or status markers. The GUIs may also be configured to enable insertion of a new node into the flowgraph at a position between existing nodes, associate the new node with one or more upstream and downstream nodes, and trigger recomputation of downstream nodes based on contextual data generated by the new node. Generally, user interactions via the GUI may trigger the selective regeneration process described herein, as described above.

### Propagating Upstream Changes Downstream Throughout the System

An LLM is inherently stateless and requires a complete chat history to generate the next response. In other words, each interaction with a node is performed using an explicit prompt that includes all relevant contextual information necessary to generate a subsequent response. Accordingly, determining the chat history and context to provide to the LLM to generate the next response is an important consideration. In certain embodiments, a graph data structure represents the autonomous workflow agents as nodes, and each node has (i) an input dependency definition, (ii) an output, and (iii) dependency metadata identifying one or more upstream context segments used to generate the output.

In the flow graphs described above, for any particular node, the context includes all of the parent nodes of the particular node. The parent nodes may provide a summary of the chat conversation with the particular node’s agent, the entire chat conversation with the particular node’s agent, just the output of the conversation with the particular node’s agent, or any combinations of the above. This process presumes that the user does not revisit any of the parent nodes.

When a user revisits a parent node, the parent node’s outcome may change, which must be propagated to the downstream nodes. For example, the user may change the assumptions in the patent node, the user may add new information to the parent node, the user may pursue a different direction, and so on. These upstream changes to the parent node may result in very different outcomes in the downstream nodes.

In certain embodiments, a reverse dependency graph may be generated to identify the parts of a parent node’s context that were actually leveraged by a child node when the child produced its output, propagate any upstream modifications to the downstream nodes that depend on the altered information, and determine whether such changes necessitate regeneration of the affected child (and, recursively, its descendants). In other words, changes in upstream nodes are detected, the reverse dependency graph is traversed, and updates are selectively propagated to downstream nodes. Selective propagation may include evaluating changes using embedding-based similarity (using a threshold condition) or evaluating an LLM to assess contextual relevance.

For each node, a context is provided that includes information from its parent nodes. When generating a response for a given node, the portions of the context that were used in producing the output are identified, such as which parent node and which segment of a summary or prior interaction were used. Accordingly, when a parent node is updated, the reverse dependency graph may be used to determine precisely which downstream child nodes require updating. In some embodiments, upon detecting a change in a parent node, an additional agent or tool computes a difference (diff) between prior and updated content and evaluates the impact on child node references. This evaluation may be performed using embedding-based similarity, such as cosine similarity, by evaluating an LLM to assess contextual relevance, and so on.

In certain embodiments, each node in the flow graphs described above represents an autonomous agent configured with a distinct set of instructions, procedural steps, and defined objectives. The output produced by each such node includes the agent’s response, such as the final text generated by the LLM, and a concise summary of the interaction between the agent and one or more parent nodes, which may be used as contextual input for downstream nodes.

In certain embodiments, contextual dependency annotation is performed for each node within the flow graph. Each node is configured to record metadata describing its reliance on upstream information sources. Such metadata may include one or more identifiers corresponding to parent nodes from which contextual material was derived, as well as references to specific segments of such material, such as text spans (e.g., sentences, phrases, etc.) or structured data elements, that were used to generate the node’s output. Additionally, each node may store a representation of its own output, such as a hash value or embedding, to facilitate efficient comparison during subsequent processing. Collectively, this metadata defines a reverse dependency graph that maps downstream nodes to the precise contextual elements upon which they depend.

In other words, the reverse dependency graph identifies relationships between upstream and downstream nodes, and the metadata identifies portions of parent node outputs used to generate a corresponding node output.

In some embodiments, changes within the reverse dependency graph may be detected and propagated. When an upstream node is modified, a difference between a prior version and an updated version of the node’s output or associated context is determined. For each downstream node, the system evaluates whether any of the modified portions of the upstream content correspond to dependencies recorded for that downstream node. Where such correspondence exists, the significance of the change is assessed using one or more evaluation techniques. For example, embedding-based similarity, such as cosine similarity, may be used to compare prior and updated representations of the affected context segments. Alternatively, or in addition, an LLM may be prompted to determine whether the downstream node’s previously generated output remains valid in view of the updated context.

Based on this evaluation, downstream nodes may be selectively regenerated. In certain embodiments, selectively regenerating downstream nodes includes automatically regenerating a first subset of downstream nodes determined to be materially impacted and preserving outputs of a second subset of downstream nodes determined not to be materially impacted.

In this manner, unnecessary recomputation is avoided by limiting updates to only those nodes whose outputs are materially impacted by upstream changes. In other words, selectively regenerating only downstream nodes reduces computational overhead by avoiding regeneration of unaffected nodes and reduces LLM invocations relative to full downstream recomputation. Regeneration may be performed automatically by invoking the corresponding agent with updated contextual inputs, or may be performed in response to user confirmation. In some embodiments, a hybrid approach is employed in which selected nodes are automatically regenerated while others are queued for manual review, based on factors such as node priority, sensitivity, or user-defined preferences.

In certain embodiments, selective regeneration decisions may further incorporate computational cost estimation models configured to estimate downstream recomputation expense associated with regeneration of one or more dependency branches. Such cost estimation models may consider factors including contextual payload size, expected inference latency, downstream dependency depth, historical execution cost metrics, model invocation expense, or available computational resources. Based on such evaluations, the system may dynamically determine whether selective regeneration, deferred regeneration, partial regeneration, or preservation of existing downstream outputs should be performed.

In certain embodiments, the system may further maintain versioned contextual states associated with one or more upstream nodes such that downstream outputs may be selectively regenerated relative to different contextual versions without requiring regeneration of unrelated execution branches. This version-aware dependency architecture enables efficient experimentation across alternative contextual assumptions while reducing unnecessary recomputation overhead across unaffected portions of the execution graph.

The reverse dependency graph provides several technical advantages. By enabling selective propagation of changes, system computational efficiency is improved by reducing the number of required LLM invocations. By maintaining explicit mappings between outputs and their originating contextual elements, contextual integrity and traceability are preserved across the flow graph. Scalability is also supported, as dependency tracking and change evaluation are localized to affected subgraphs, and user transparency is enhanced by allowing users to inspect how modifications to upstream information influence downstream outputs.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A computer system, comprising:
a memory storing instructions and a graph data structure representing a plurality of autonomous workflow agents as nodes, each node having (i) an input dependency definition, (ii) an output, and (iii) dependency metadata identifying one or more upstream context segments used to generate the output; and
one or more processors configured to:
receive updated context associated with an upstream node;
compare the updated context with prior context for the upstream node to identify a changed portion;
traverse a reverse dependency graph that maps downstream nodes to the upstream context segments used in generation of respective downstream outputs;
determine, for each downstream node, whether the changed portion corresponds to a recorded upstream context segment identified in the dependency metadata for that downstream node;
evaluate whether the changed portion materially affects the downstream node based on correspondence to recorded upstream context segments using at least one of (a) embedding similarity between a prior context segment and an updated context segment or (b) language-model-based contextual relevance analysis;
selectively regenerate only downstream nodes determined to be materially impacted based on the evaluation, while preserving outputs of downstream nodes not determined to be materially impacted; and
wherein selectively regenerating only downstream nodes reduces computational overhead by avoiding regeneration of unaffected nodes and reduces large language model (LLM) invocations relative to full downstream recomputation.

2. The computer system of claim 1, wherein:
each node includes an input dependency definition specifying one or more required input types, and
the one or more processors are configured to instantiate the node only upon satisfaction of the input dependency definition by user input data or upstream node output data.

3. The computer system of claim 1, wherein the dependency metadata further identifies, for each downstream node, one or more specific segments of upstream context comprising at least one of text spans, structured data elements, or embeddings used to generate the output of the downstream node.

4. The computer system of claim 1, wherein the reverse dependency graph is constructed by mapping each downstream node to identifiers of upstream nodes and corresponding context segments recorded in the dependency metadata.

5. The computer system of claim 1, wherein comparing the updated context with the prior context comprises generating a difference representation identifying modified portions of upstream node output data.

6. The computer system of claim 1, wherein whether the changed portion materially affects the downstream node comprises computing a similarity metric between a prior context segment and an updated context segment using vector embeddings and determining whether the similarity metric satisfies a threshold condition.

7. The computer system of claim 1, wherein whether the changed portion materially affects the downstream node further comprises providing at least a portion of the updated context and prior context to an LLM to determine whether a previously generated downstream output remains valid.

8. The computer system of claim 1, wherein selectively regenerating downstream nodes comprises automatically regenerating a first subset of downstream nodes determined to be materially impacted and preserving outputs of a second subset of downstream nodes determined not to be materially impacted.

9. The computer system of claim 1, wherein the one or more processors are further configured to execute multiple candidate downstream nodes having satisfied input dependency definitions concurrently to generate multiple outputs, and to rank or filter the outputs based on one or more evaluation criteria.

10. The computer system of claim 1, wherein the one or more processors are further configured to associate each context segment with temporal metadata and to weight selection of context segments for downstream node execution based on at least one of recency, interaction frequency, or assigned relevance score.

11. A computer-implemented method for managing execution of a plurality of autonomous workflow agents, the method comprising:
storing, in memory, a graph data structure representing the plurality of autonomous workflow agents as nodes, each node having (i) an input dependency definition, (ii) an output, and (iii) dependency metadata identifying one or more upstream context segments used to generate the output;
receiving updated context associated with an upstream node;
comparing the updated context with prior context for the upstream node to identify a changed portion;
traversing a reverse dependency graph that maps downstream nodes to upstream context segments used in generation of respective downstream outputs;
determining, for each downstream node, whether the changed portion corresponds to a recorded upstream context segment identified in the dependency metadata;
evaluating whether the changed portion materially affects the downstream node based on correspondence to recorded upstream context segments using at least one of (a) embedding similarity between a prior context segment and an updated context segment or (b) language-model-based contextual relevance analysis;
selectively regenerating only downstream nodes determined to be materially impacted based on the evaluation while preserving outputs of downstream nodes not determined to be materially impacted; and
wherein selectively regenerating only downstream nodes reduces computational overhead by avoiding regeneration of unaffected nodes and reduces large language model (LLM) invocations relative to full downstream recomputation.

12. The method of claim 11, wherein each node is instantiated only upon satisfaction of its input dependency definition by user input data or upstream node output data.

13. The method of claim 11, wherein the dependency metadata further identifies specific segments of upstream context comprising at least one of text spans, structured data elements, or vector embeddings used to generate the output of a downstream node.

14. The method of claim 11, wherein the reverse dependency graph is constructed by mapping each downstream node to identifiers of upstream nodes and corresponding context segments recorded in the dependency metadata.

15. The method of claim 11, wherein comparing the updated context with the prior context comprises generating a difference representation identifying modified portions of upstream node output data.

16. The method of claim 11, wherein whether the changed portion materially affects the downstream node comprises computing a similarity metric between a prior context segment and an updated context segment using vector embeddings and determining whether the similarity metric satisfies a threshold condition.

17. The method of claim 11, wherein whether the changed portion materially affects the downstream node further comprises providing at least a portion of the updated context and prior context to an LLM to determine whether a previously generated downstream output remains valid.

18. The method of claim 11, wherein selectively regenerating downstream nodes comprises automatically regenerating a first subset of downstream nodes determined to be materially impacted and preserving outputs of a second subset of downstream nodes determined not to be materially impacted.

19. The method of claim 11, further comprising executing multiple candidate downstream nodes having satisfied input dependency definitions concurrently to generate multiple outputs, and ranking or filtering the outputs based on one or more evaluation criteria.

20. The method of claim 11, further comprising associating each context segment with temporal metadata and weighting selection of context segments for downstream node execution based on at least one of recency, interaction frequency, or assigned relevance score.

21. A computer system, comprising:
a memory storing instructions and a graph data structure representing a plurality of autonomous workflow agents as nodes, each node being associated with (i) an input dependency definition specifying one or more required inputs and (ii) an output; and
one or more processors configured to:
receive input data associated with at least one node;
for each of a plurality of candidate nodes comprising nodes having input dependency definitions that may be satisfied, determine whether the input dependency definition of that candidate node is satisfied by at least one of the input data or output data of one or more upstream nodes;
responsive to determining that the input dependency definition of a first subset of candidate nodes is satisfied, instantiate the first subset of candidate nodes as active nodes within the graph data structure;
execute the active nodes to generate output data corresponding to their respective output;
dynamically identify, based on the output data, one or more additional candidate nodes having input dependency definitions satisfied by the output data; and
iteratively instantiate and execute the additional candidate nodes to expand the graph data structure without requiring a predefined execution sequence.

22. The computer system of claim 21, wherein determining whether the input dependency definition is satisfied comprises evaluating whether required input types are present within at least one of user-provided input data, upstream node outputs, or retrieved contextual data.

23. The computer system of claim 21, wherein the one or more processors are further configured to dynamically select among multiple candidate nodes having satisfied input dependency definitions based on at least one of semantic similarity, contextual relevance, or alignment with a global goal.

24. The computer system of claim 21, wherein multiple candidate nodes having satisfied input dependency definitions are instantiated and executed concurrently to generate multiple outputs.

25. The computer system of claim 21, wherein the graph data structure is dynamically expanded by adding nodes as children of upstream nodes whose outputs satisfy the input dependency definitions of the added nodes.

26. The computer system of claim 21, wherein at least one node is configured to request additional input data from a user or from another node when its input dependency definition is not satisfied.

27. The computer system of claim 21, wherein at least one node is configured to identify and suggest one or more additional candidate nodes capable of satisfying an unmet input dependency.

28. The computer system of claim 21, wherein the one or more processors are further configured to dynamically route execution among nodes using one or more routing agents that select downstream nodes based on at least one of input dependency satisfaction, contextual relevance, or inferred alignment with a global objective.

29. The computer system of claim 28, wherein the routing agents evaluate candidate nodes based on semantic similarity and patterns of prior interactions.

30. The computer system of claim 21, wherein the computer system operates without a predefined workflow sequence and without a centralized orchestration model.

31. A computer-implemented method for managing execution of a plurality of autonomous workflow agents, the method comprising:
storing a graph data structure representing the plurality of autonomous workflow agents as nodes, each node having an input dependency definition and an output;
receiving input data;
for each of a plurality of candidate nodes, determining whether the input dependency definition of that candidate node is satisfied by at least one of the input data or output data of one or more upstream nodes;
instantiating, as active nodes, candidate nodes whose input dependency definitions are satisfied;
executing the active nodes to generate output data;
identifying additional candidate nodes whose input dependency definitions are satisfied by the output data; and
iteratively instantiating and executing the additional candidate nodes to dynamically expand the graph data structure without requiring a predefined execution sequence.

32. A computer system, comprising:
a graphical user interface (GUI) configured to be presented on a client device;
a memory storing instructions and a graph data structure representing a plurality of nodes corresponding to autonomous workflow agents; and
one or more processors configured to:
present, via the GUI, a flowgraph comprising the plurality of nodes and edges representing dependency relationships between the nodes;
receive, via the GUI, user interaction selecting a first node of the plurality of nodes;
in response to the user interaction, present a node-specific interface that displays (i) output generated by the first node and (ii) contextual inputs associated with one or more upstream nodes;
receive, via the node-specific interface, modified input data associated with the first node or modified contextual data associated with the first node;
detect a change in the contextual data associated with the first node; and
trigger, based on the detected change, selective regeneration of one or more downstream nodes dependent on the first node.

33. The computer system of claim 32, wherein triggering selective regeneration comprises:
identifying, using a dependency graph, downstream nodes that depend on at least a portion of the modified contextual data; and
automatically updating outputs of only those downstream nodes determined to be impacted by the modified contextual data.

34. The computer system of claim 32, wherein the GUI is further configured to:
visually indicate, within the flowgraph, nodes affected by the detected change using one or more visual indicators comprising highlighting, color changes, or status markers.

35. The computer system of claim 32, wherein the GUI is further configured to:
receive a user selection specifying whether regeneration of downstream nodes is to be performed automatically, manually, or in a hybrid mode in which a subset of nodes is automatically regenerated and another subset is presented for user confirmation.

36. The computer system of claim 32, wherein the GUI is further configured to:
enable insertion of a new node into the flowgraph at a position between existing nodes,
associate the new node with one or more upstream and downstream nodes, and
trigger recomputation of downstream nodes based on contextual data generated by the new node.
